(19) United States
(12) Patent Application Publication
(10) Pub. No.: US 2015/0203099 A1
(43) Pub. Date: Jul. 23, 2015

(54) CONTROL DEVICE OF VEHICULAR DRIVE

(71) Applicant: AISIN AW CO., LTD., Anjo-shi, Aichi-ken (JP)

(72) Inventors: Satoru Kasuya, Nishio (JP); Masashi Kito, Anjo (JP); Toshio Okoshi, Kota (JP); Shigeru Sugisaka, Nishio (JP)

(73) Assignee: AISIN AW CO., LTD., Anjo-shi, Aichi-ken (JP)

(21) Appl. No.: 14/414,594

(22) PCT Filed: Sep. 4, 2013
(86) PCT No.: PCT/JP2013/073804

§ 371 Date: Jan. 13, 2015

(30) Foreign Application Priority Data
Sep. 6, 2012 (JP) 2012-196473

(51) Int. Cl. B60W 20/00; B60W 10/11; B60W 10/02; B60W 10/08; B60W 30/18; B60W 30/186

(52) U.S. Cl. CPC B60W 20/108; B60W 30/18027; B60W 30/186; B60W 10/02; B60W 10/08; B60W 10/11; Y10S 903/93

(57) ABSTRACT

Provided is a control device such that, when a first engaging device (CL1) is controlled in a sliding engagement state, a decrease in torque transmitted to a wheel (W) in the event of an increase of the temperature of an engaging member of the first engaging device (CL1) is suppressed, while a temperature increase of the engaging member is suppressed. The control device is provided with: a first engagement slide control unit that controls a second engaging device (CL2) to a direct-connection engagement state during a rotating operation of an internal combustion engine (E), and that controls the first engaging device (CL1) to the sliding engagement state; and a temperature increase suppressing control unit that causes an output torque of a rotating electrical machine (MG) to be increased while causing a transmission torque of the first engaging device (CL1) to be decreased when the temperature of the first engaging device (CL1) is increased during first engagement slide control.

### TECHNICAL FIELD

Preferred embodiments relate to a control device that controls a vehicular drive device in which a first engagement device, a rotary electric machine, and a second engagement device are arranged in this order from an internal combustion engine side on a power transmission path that connects an internal combustion engine to wheels.

### BACKGROUND ART

A technology described in Patent Document 1 is already known as an example of the control device of the vehicular drive device described above. The technology described in Patent Document 1 discloses the control device that is configured to, in a case in which a start acceleration request of a driver is detected, control a first engagement device so as to be in a slip engaged state and transmit output torque of the internal combustion engine to the wheels to start a vehicle.

### RELATED ART DOCUMENT

### Patent Document

Patent Document 1: Japanese Patent Application Publication No. 2012-6575 (JP 2012-6575 A)

### SUMMARY

### Problem to be Solved

However, Patent Document 1 does not disclose a technology to deal with a case in which an amount of heat generation due to friction between engagement members of the first engagement device that is in the slip engaged state is large and an increase in temperature of the engagement members exceeds an allowable range.

Therefore, the control devices are required, which are capable of suppressing an increase in the temperature of the engagement members and suppressing a decrease in torque that is transmitted to the wheels, in a case in which the temperature of the engagement members of the first engagement device increases while the first engagement device is controlled so as to be in a slip engaged state.

### Means for Solving the Problem

A control device according to a preferred embodiment controls a vehicular drive device in which a first engagement device, a rotary electric machine, and a second engagement device are arranged in this order from an internal combustion engine side on a power transmission path that connects the internal combustion engine to wheels, is characterized by comprising: a first engagement slip control section that performs first engagement slip control that, during rotation operation of the internal combustion engine, controls the second engagement device so as to be in a direct engaged state and the first engagement device so as to be in a slip engaged state; and a temperature increase suppression control section that, in a case in which temperature of the first engagement device increases during the first engagement slip control, causes output torque of the rotary electric machine to increase and causes transmission torque of the first engagement device to decrease.

The term “rotary electric machine” in the present application refers to any of a motor (electric motor), a generator (electric generator), and a motor generator that functions both as a motor and as a generator as necessary.

According to the aforementioned characterized configuration, in a case in which the temperature of the first engagement device increases, the transmission torque of the first engagement device is caused to decrease. Therefore, it is possible to cause an amount of heat generation due to friction between the engagement members of the first engagement device to decrease and suppress an increase in the temperature of the first engagement device. In addition, the output torque of the rotary electric machine is caused to increase. Therefore, it is possible to suppress that torque that is transmitted to the wheels decreases.

Here, it is preferable that the temperature increase suppression control section causes the transmission torque of the first engagement device to decrease to a value that is greater than zero.

According to the aforementioned configuration, it is possible to, while suppressing the increase in the temperature of the first engagement device, maintain the first engagement device so as to be in the slip engaged state and transmit the output torque of the internal combustion engine to the wheels side.

In addition, it is preferable that, in a case in which the temperature of the first engagement device increases in a state in which rotation of the wheels has stopped during the first engagement slip control, the temperature increase suppression control section executes slip transition control that causes the second engagement device to transition from the direct engaged state to the slip engaged state and causes rotational speed of the rotary electric machine to increase, and causes the output torque of the rotary electric machine to increase and the transmission torque of the first engagement device to decrease.

In a case in which torque is outputted at the rotary electric machine in a state in which the rotation of the rotary electric machine has stopped, coil where current flows does not switch along with the rotation and a current continues to flow in a part of the coil. Thereby, heat generation is concentrated at a part of the coil and a part of a switching elements, which may cause an increase in the temperature of a part of the coil and a part of the switching elements. Therefore, in a case in which the rotation of the wheels has stopped and the rotation of the rotary electric machine has stopped, torque that is able to be outputted at the rotary electric machine while suppressing an increase in temperature is limited. Therefore, it may not be possible to cause the rotary electric machine to output sufficient torque.

According to the aforementioned configuration, in a case in which it is determined that the rotation of the wheels has stopped and the temperature of the first engagement device increases, the second engagement device is caused to transition from the direct engaged state to the slip engaged state and the rotational speed of the rotary electric machine is caused to increase. Therefore, concentrated heat generation at the coil, etc. can be suppressed even when torque is outputted at the rotary electric machine. It is possible to cause the output torque of the rotary electric machine to increase compared to a state in which the rotation of the rotary electric machine has stopped. Thereby, even in a case in which the rotation of the wheels has stopped, it is possible to cause the output torque of the rotary electric machine to increase and the transmission torque of the first engagement device to decrease. Therefore, it is possible to suppress that the torque that is transmitted to the wheels decreases while suppressing an increase in the temperature of the first engagement device.

Especially, in a case in which the vehicle is located at an uphill road, driving torque becomes large and the amount of heat generation in the first engagement device becomes large even in a state in which the rotation of the wheels has stopped. Even in such a case, according to the aforementioned configuration, it is possible to suppress that the torque that is transmitted to the wheels decreases while suppressing an increase in the temperature of the first engagement device.

In addition, it is preferable that, in a case in which the temperature of the first engagement device increases in a state in which rotation of the wheels has stopped during the first engagement slip control, the temperature increase suppression control section executes direct engagement maintaining control that causes the output torque of the rotary electric machine to increase and causes the transmission torque of the first engagement device to decrease while continuing to control the second engagement device so as to be in the direct engaged state.

According to the aforementioned configuration, even in a case in which the rotation of the wheels has stopped, the output torque of the rotary electric machine is caused to increase and the transmission torque of the first engagement device is caused to decrease in a state in which the second engagement device continues to be controlled so as to be in the direct engagement. Therefore, it is possible to suppress the increase in the temperature of the first engagement device. Thereby, without causing an increase rate of the temperature of the first engagement device to decrease or causing the second engagement device to transition to the slip engaged state as described above, it is possible to suppress the increase in the temperature of the first engagement device.

In addition, it is preferable that, in a state in which rotation of the wheels has stopped during the first engagement slip control, in a case in which the temperature of the first engagement device exceeds a predetermined first threshold value, the temperature increase suppression control section executes direct engagement maintaining control that causes the output torque of the rotary electric machine to increase and causes the transmission torque of the first engagement device to decrease while continuing to control the second engagement device so as to be in the direct engaged state, and in a case in which the temperature of the first engagement device exceeds a predetermined second threshold value that is greater than the first threshold value, the temperature increase suppression control section executes slip transition control that causes the second engagement device to transition from the direct engaged state to the slip engaged state and causes rotational speed of the rotary electric machine to increase, and causes the output torque of the rotary electric machine to increase and the transmission torque of the first engagement device to decrease.

According to the aforementioned characterized configuration, in a case in which the temperature of the first engagement device exceeds the first threshold value in a state in which rotation of the wheels has stopped, it is possible to suppress an increase in the temperature of the first engagement device by causing the output torque of the rotary electric machine to increase and the transmission torque of the first engagement device to decrease while continuing to control the second engagement device so as to be in the direct engaged state. However, in a state in which rotation of the rotary electric machine has stopped, the suppression of the increase in the temperature of the first engagement device may be not sufficient because of limitation caused by an increase in the temperature of the rotary electric machine as mentioned above. Therefore, in a case in which the temperature of the first engagement device exceeds the second threshold value that is greater than the first threshold value, the second engagement device is caused to transition from the direct engaged state to the slip engaged state, and the rotational speed of the rotary electric machine is caused to increase. Therefore, it is possible to cause the output torque of the rotary electric machine to increase and the transmission torque of the first engagement device to decrease without the limitation that is caused by an increase in the temperature of the rotary electric machine as mentioned above. Thereby, it is possible to appropriately suppress the increase in the temperature of the first engagement device.

On the other hand, in a case in which the increase in temperature can be appropriately suppressed without the temperature of the first engagement device exceeding the second threshold value while continuing to control the second engagement device so as to be in the direct engaged state, it is possible to suppress the increase in the temperature of the first engagement device without causing the second engagement device to transition to the slip engaged state.

In addition, it is preferable that, in a case in which the temperature of the first engagement device increases in a state in which the wheels are rotating during the first engagement slip control, the temperature increase suppression control section executes during-rotation control that causes the output torque of the rotary electric machine to increase and the transmission torque of the first engagement device to decrease while continuing to control the second engagement device so as to be in the direct engaged state.

In a state in which the wheels are rotating and the rotary electric machine is rotating, in order to suppress the increase in the temperature of the first engagement device, it is possible to cause the rotary electric machine to output large torque compared to a state in which the rotation has stopped. According to the aforementioned configuration, in a case in which the temperature of the first engagement device increases in a state in which the wheels are rotating, it is possible to cause the transmission torque of the first engagement device to decrease and the output torque of the rotary electric machine to increase. Thereby, in a case in which the wheels are rotating, it is possible to suppress the increase in the temperature of the first engagement device and suppress that torque transmitted to the wheels decreases.

In addition, it is preferable that, in causing the output torque of the rotary electric machine to increase and the transmission torque of the first engagement device to decrease, the temperature increase suppression control section causes the transmission torque of the first engagement device to decrease in accordance with an amount of increase in the output torque of the rotary electric machine.

According to the aforementioned configuration, the transmission torque of the first engagement device is caused to decrease in accordance with the amount of increase in the output torque of the rotary electric machine. Therefore, it is possible to maintain the torque transmitted to the wheels.

In addition, it is preferable that, in causing the output torque of the rotary electric machine to increase and the transmission torque of the first engagement device to decrease in the slip transition control, the temperature increase suppression control section causes the transmission torque of the first engagement device to decrease such that an increase in the temperature of the first engagement device becomes within a predetermined allowable range and causes the output torque of the rotary electric machine to increase in accordance with an amount of decrease in the transmission torque of the first engagement device.

According to the aforementioned configuration, even in a case in which the rotation of the wheels has stopped, it is possible to suppress the increase in the temperature of the first engagement device so as to be within the allowable range and maintain the torque transmitted to the wheels.

In addition, it is preferable that, in causing the output torque of the rotary electric machine to increase and the transmission torque of the first engagement device to decrease in the direct engagement maintaining control, the temperature increase suppression control section causes the output torque of the rotary electric machine to increase to an extent that an increase in the temperature of the rotary electric machine becomes within a predetermined allowable range in a state in which rotation of the rotary electric machine has stopped and causes the transmission torque of the first engagement device to decrease in accordance with an amount of increase in the output torque of the rotary electric machine.

According to the aforementioned configuration, even in a case in which the rotation of the wheels has stopped, the output torque of the rotary electric machine is caused to increase to the extent that the increase in the temperature of the coil of the rotary electric machine, etc. becomes within an allowable range in a state in which the rotation of the rotary electric machine has stopped and the transmission torque of the first engagement device is caused to decrease in accordance with the amount of increase in the output torque of the rotary electric machine. Therefore, it is possible to suppress the increase in the temperature of the first engagement device. Thereby, without causing an increase rate of the temperature of the first engagement device to decrease or causing the second engagement device to transition to the slip engaged state as described above, it is possible to suppress the increase in the temperature of the first engagement device so as to be within the allowable range.

In addition, it is preferable that, in causing the output torque of the rotary electric machine to increase and the transmission torque of the first engagement device to decrease in the during-rotation control, the temperature increase suppression control section causes the transmission torque of the first engagement device to decrease such that an increase in the temperature of the first engagement device becomes within a predetermined allowable range and causes the output torque of the rotary electric machine to increase in accordance with an amount of decrease in the transmission torque of the first engagement device.

According to the aforementioned configuration, in a case in which it is determined that the wheels are rotating and the temperature of the first engagement device increases, it is possible to cause the transmission torque of the first engagement device to decrease such that the increase in the temperature of the first engagement device becomes within the predetermined allowable range and causes the output torque of the rotary electric machine to increase in accordance with an amount of decrease in the transmission torque of the first engagement device. Therefore, in a case in which the wheels are rotating, it is possible to maintain the torque transmitted to the wheels while suppressing the increase in the temperature of the first engagement device.

In addition, it is preferable that, after the second engagement device is caused to transition to the slip engaged state in the slip transition control and the wheels start to rotate, the temperature increase suppression control section causes the second engagement device to transition from the slip engaged state to the direct engaged state.

Once the wheels start to rotate, it is possible to cause the rotary electric machine to rotate even in a case in which the second engagement device is caused to transition to the direct engaged state. Thereby, it is possible to cause the output torque of the rotary electric machine to increase compared to when the rotation of the rotary electric machine has stopped. According to the aforementioned configuration, after the wheels start to rotate, the second engagement device is caused to transition from the slip engaged state to the direct engaged state. Therefore, it is possible to prevent the heat generation due to friction between the engagement members of the second engagement device and suppress that the durability of the second engagement device worsens.

In addition, it is preferable that, after the second engagement device is caused to transition to the slip engaged state in the slip transition control and the wheels start to rotate, the temperature increase suppression control section causes the first engagement device to transition from the slip engaged state to the direct engaged state, and thereafter, causes the second engagement device to transition from the slip engaged state to the direct engaged state.

According to the aforementioned configuration, even in a case in which torque shock occurs in causing the first engagement device to transition to the direct engaged state, it is possible to suppress that the torque shock is transmitted to the wheels because the second engagement device is in the slip engaged state.

In the present application, the expression “drivingly coupled” refers to a state in which two rotating elements are coupled together such that a driving force can be transmitted between the two rotating elements, and is used as a concept including a state in which the two rotating elements are coupled together so as to rotate together, or a state in which the two rotating elements are coupled together such that the driving force can be transmitted between the two rotating elements via one or more transmission members. Such transmission members include various kind of members that transmit rotation at the same speed or at a shifted speed, and include, e.g., a shaft, a gear mechanism, a belt, a chain, etc. In addition, such transmission members may include an engagement element that selectively transmits rotation and a driving force, such as, e.g., a friction clutch, a meshing clutch, etc.

### BRIEF DESCRIPTION OF THE DRAWINGS

FIG. 1 is a schematic diagram showing a schematic configuration of a vehicular drive device and a control device according to an embodiment.

FIG. 2 is a block diagram showing a configuration of the control device according to an embodiment.

FIG. 3 is a flow chart showing processing of the control device according to the an embodiment.

FIG. 4 is a timing chart showing processing of the control device in a case in which rotation of wheels has stopped.

FIG. 5 is a timing chart showing processing of the control device in a case in which the wheels are rotating.

FIG. 6 is a flow chart showing processing of the control device according to another embodiment.

FIG. 7 is a timing chart showing processing of the control device in a case in which the rotation of wheels has stopped according to another embodiment.

FIG. 8 is a schematic diagram showing a schematic configuration of a vehicular drive device and a control device according to another embodiment.

FIG. 9 is a schematic diagram showing a schematic configuration of a vehicular drive device and a control device according to a further embodiment.

### BEST MODES

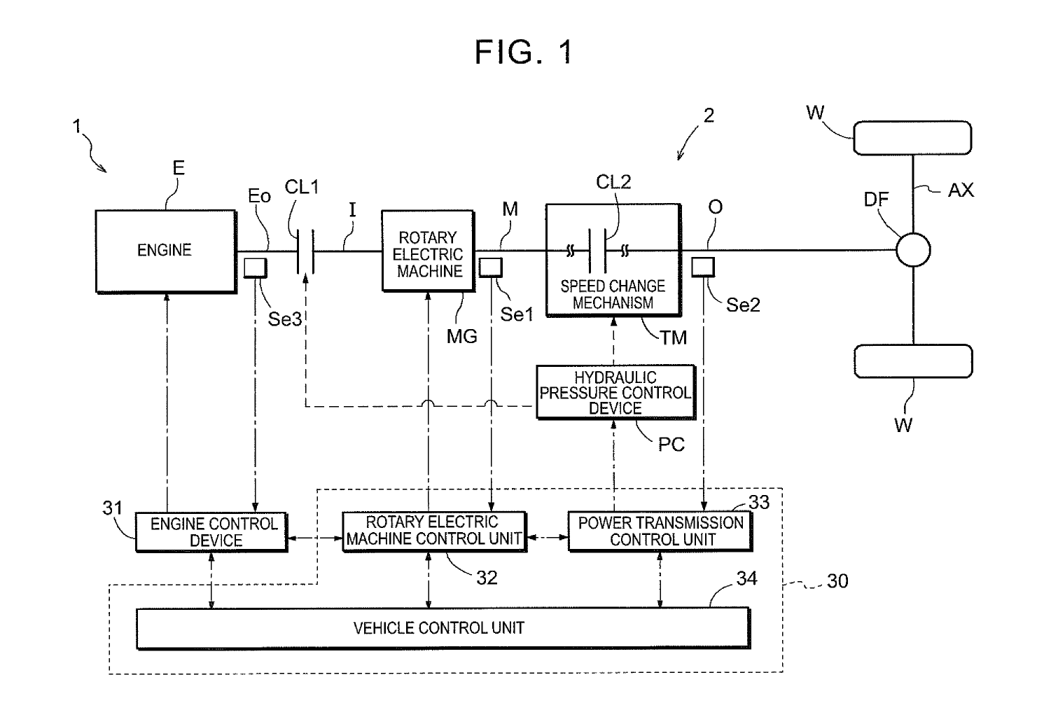

A control device 30 (hereinafter, simply referred to as control device 30) of a vehicular drive device 1 according to a preferred embodiment will be described with reference to the drawings. FIG. 1 is a schematic diagram showing a schematic configuration of the vehicular drive device 1 and the control device 30 according to the present embodiment. In this figure, a solid line indicates a transmission path of a driving force, a dashed line indicates a supply path of hydraulic oil, and a dashed dotted line indicates a transmission path of signals. As shown in this figure, the vehicular drive device 1 according to the present embodiment schematically includes an engine E and a rotary electric machine MG as driving force sources and is configured to transmit a driving force from these driving force sources to wheels W through a power transmission mechanism. The vehicular drive device 1 includes a first engagement device CL1, the rotary electric machine MG, and a second engagement device CL2 in this order from the engine E side on a power transmission path 2 that connects the engine E with the wheels W. The first engagement device CL1 is selectively brought into a coupled state or a released state between the engine E and the rotary electric machine MG in accordance with the engagement state. The second engagement device CL2 is selectively brought into a coupled state or a released state between the rotary electric machine MG and the wheels W in accordance with the engagement state. The vehicular drive device 1 according to the present embodiment includes a speed change mechanism TM provided on the power transmission path 2 between the rotary electric machine MG and the wheels W. The second engagement device CL2 is one of a plurality of engagement devices provided in the speed change mechanism TM.

A hybrid vehicle includes the control device 30 that controls the vehicular drive device 1. The control device 30 according to the present embodiment includes: a rotary electric machine control unit 32 that performs control for the rotary electric machine MG; a power transmission control unit 33 that performs control for the speed change mechanism TM, the first engagement device CL1, and the second engagement device CL2; and a vehicle control unit 34 that integrates these control devices and performs control for the vehicular drive device 1. In addition, the hybrid vehicle includes an engine control device 31 that performs control for the engine E.

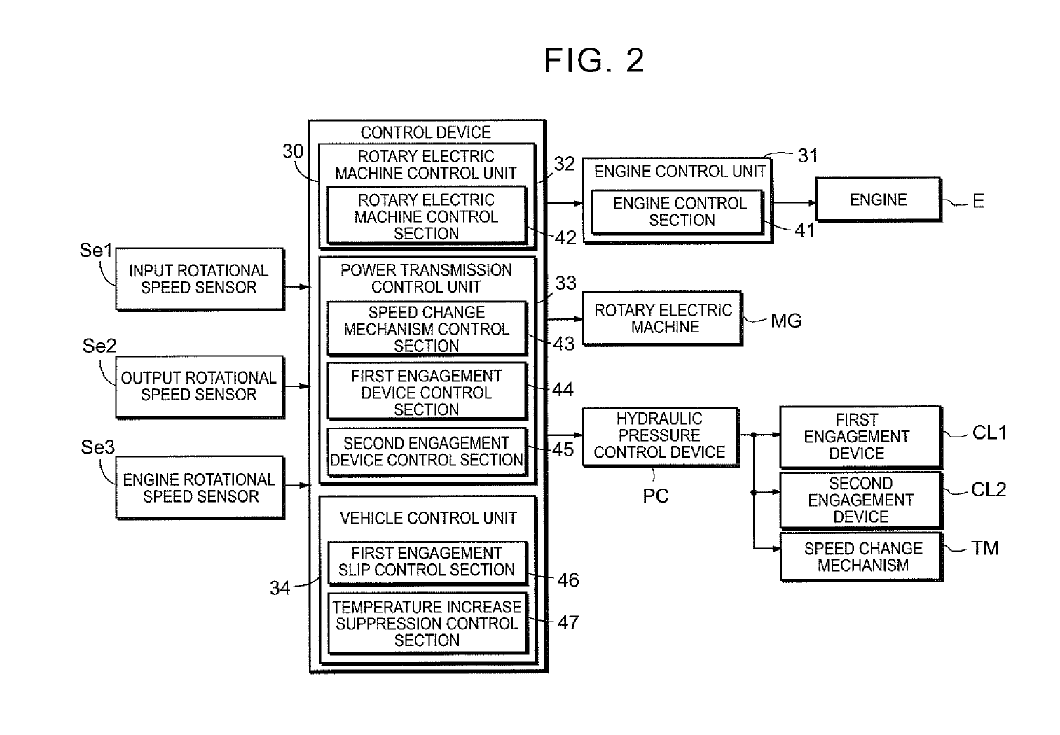

As shown in FIG. 2, the control device 30 is characterized by including: a first engagement slip control section 46 that performs first engagement slip control that, during rotation operation of the engine E, controls the second engagement device CL2 so as to be in the direct engaged state and controls the first engagement device CL1 so as to be in the slip engaged state; and a temperature increase suppression control section 47 that performs temperature increase suppression control that, in a case in which the temperature of the first engagement device CL1 increases, causes the output torque of the rotary electric machine MG to increase and the transmission torque of the first engagement device CL1 to decrease.

Hereinafter, the vehicular drive device 1 and the control device 30 according to the present embodiment are explained in detail.

1. Configuration of Vehicular Drive Device 1

Initially, the configuration of the vehicular drive device 1 of a hybrid vehicle according to the present embodiment is explained. As shown in FIG. 1, the hybrid vehicle includes the engine E and the rotary electric machine MG as the driving force sources of the vehicle and is a parallel type hybrid vehicle in which the engine E and the rotary electric machine MG are drivingly coupled in series. The hybrid vehicle includes the speed change mechanism TM, and using the speed change mechanism TM, shifts the rotational speed of the engine E and the rotary electric machine MG transmitted to an intermediate shaft M, converts the torque, and transmits the resultant rotational speed and torque to an output shaft O.

The engine E is an internal combustion engine driven by combusting fuel. Various kinds of known engines, for example, a gasoline engine, a diesel engine, etc. are used as the engine E. In the present example, an engine output shaft Eo, such as a crankshaft, of the engine E is selectively drivingly coupled to the input shaft I via the first engagement device CL1. The input shaft I is drivingly coupled to the rotary electric machine MG. That is, the engine E is selectively drivingly coupled to the rotary electric machine MG via the first engagement device CL1 serving as a friction engagement element. In addition, the engine output shaft Eo is provided with a damper (not shown) and is configured to be capable of damping fluctuations in output torque and the rotational speed due to intermittent combustion of the engine E and transmitting the torque and rotational speed to the wheels W side.

The rotary electric machine MG includes a stator fixed to a non-rotatable member and a rotor that is rotatably supported in an inward radial direction at a position facing the stator. The rotor of the rotary electric machine MG is drivingly coupled to the input shaft I and the intermediate shaft M so as to rotate together. That is, in the present embodiment, both engine E and the rotary electric machine MG are configured to be drivingly coupled to the input shaft I and the intermediate shaft M. The rotary electric machine MG is electrically connected to a battery serving as an electricity storage device via an inverter that performs conversion between direct current and alternating current. The rotary electric machine MG is capable of performing a function as a motor (an electric motor) that generates motive power when receiving electric power supply and a function as a generator (an electric generator) that generates electric power when receiving motive power supply. That is, the rotary electric machine MG is supplied with electric power from the battery via the inverter to perform power running, or generates electric power using a rotational driving force transmitted from the engine E or the wheels W to store the generated electric power in the battery via the inverter.

The intermediate shaft M that is drivingly coupled to the driving force sources is drivingly coupled to the speed change mechanism TM. In the present embodiment, the speed change mechanism TM is an automatic speed change mechanism that includes a plurality of shift speeds with different speed ratios. In order to establish the plurality of shift speeds, the speed change mechanism TM includes a gear mechanism such as a planetary gear mechanism, and a plurality of engagement devices. In the present embodiment, one of the plurality of engagement devices is the second engagement device CL2. The speed change mechanism TM shifts the rotational speed of the intermediate shaft M at a speed ratio set for each shift speed and converts the torque thereof, and transmits the resultant rotational speed and torque to the output shaft O. The torque transmitted from the speed change mechanism TM to the output shaft O is distributed and transmitted to axle shafts AX on the right and left sides through an output differential gear device DF, and thereafter transmitted to the wheels W that are coupled to the respective axle shafts AX. The speed ratio here is a ratio of the rotational speed of the intermediate shaft M to the rotational speed of the output shaft O when each shift speed is established in the speed change mechanism TM. In the present application, the speed ratio is a value acquired by dividing the rotational speed of the intermediate shaft M by the rotational speed of the output shaft O. That is, the rotational speed acquired by dividing the rotational speed of the intermediate M by the speed ratio is the rotational speed of the output shaft O. In addition, the torque acquired by multiplying the torque transmitted from the intermediate shaft M to the speed change mechanism TM by the speed ratio is the torque transmitted from the speed change mechanism TM to the output shaft O.

In the present example, a plurality of engagement devices (including the second engagement device CL2) in the speed change mechanism TM and the first engagement device CL1 are friction engagement elements such as clutches, brakes, etc., each including friction members. These friction engagement elements are capable of continuously controlling an increase and a decrease in the transmission torque capacity by controlling the hydraulic pressure that is supplied to control the engagement pressure. It is preferable to utilize, for example, a wet multi-plate clutch, a wet multi-plate brake, etc. as such friction engagement elements.

The friction engagement element transmits torque between engagement members with friction between the engagement members. In a case in which there is a rotational difference (slip) between the engagement members of the friction engagement element, the torque (slip torque) of the magnitude of the transmission torque capacity is transmitted from the member with a higher rotational speed to the member with a lower rotational speed with dynamic friction. In a case in which there is no rotational difference (slip) between the engagement members of the friction engagement element, the friction engagement element transmits the torque acting between the engagement members of the friction engagement element with static friction up to the magnitude of the transmission torque capacity. The transmission torque capacity here is the maximum magnitude of torque that can be transmitted with friction by the friction engagement element. The magnitude of the transmission torque capacity changes in proportion to the engagement pressure of the friction engagement element. The engagement pressure is a pressure at which an input-side engagement member (a friction plate) and an output-side engagement member (a friction plate) press each other. In the present embodiment, the engagement pressure changes in proportion to the magnitude of the hydraulic pressure that is supplied. That is, in the present embodiment, the magnitude of the transmission torque capacity changes in proportion to the magnitude of the hydraulic pressure that is supplied to the friction engagement element.

Each friction engagement element includes a return spring and is urged toward a disengagement side by a reaction force of the spring. When the force generated by the hydraulic pressure that is supplied to a hydraulic cylinder of each friction engagement element exceeds the reaction force of the spring, the transmission torque capacity starts to be generated in the friction engagement element and the friction engagement element changes from the disengaged state to the engaged state. The hydraulic pressure at the time when the transmission torque capacity starts to be generated is referred to as “stroke end pressure.” Each friction engagement element is configured such that the transmission torque capacity increases in proportion to the increase in the hydraulic pressure after the hydraulic pressure that is supplied exceeds the stroke end pressure. In addition, the friction engagement element may be configured not to include a return spring and to be controlled with differential pressure generated on both sides of a piston of the hydraulic cylinder.

In the present embodiment, the engaged state means a state in which transmission torque capacity is generated in the friction engagement element and includes the slip engaged state and the direct engaged state. The disengaged state means a state in which no transmission torque capacity is generated in the friction engagement element. The slip engaged state means an engaged state in which there is a rotational speed difference (slip) between the engagement members of the friction engagement element. The direct engaged state means an engaged state in which there is no rotational speed difference (slip) between the engagement members of the friction engagement element. In addition, a non-direct engaged state means an engaged state other than the direct engaged state and includes the disengaged state and the slip engaged state.

Note that there are cases in which transmission torque capacity is generated in the friction engagement element due to a drag between the engagement members (friction members) even in a case in which a request to generate transmission torque capacity is not provided by the control device 30. For example, even in a case in which the friction members are not pressed to each other by the piston, there are cases in which the friction members contact with each other and transmission torque capacity is generated due to a drag between the friction members. Thus, the term “disengaged state” also includes a state in which transmission torque capacity is generated due to a drag between the friction members in a case in which a request to generate the transmission torque capacity is not provided to the friction engagement device by the control device 30.

2. Configuration of Hydraulic Control System

A hydraulic control system of the vehicular drive device 1 includes a hydraulic pressure control device PC that regulates the hydraulic pressure of hydraulic oil that is supplied from an oil pump to a specified pressure. The oil pump is driven by a driving force source of the vehicle or an exclusive motor. Detailed explanation is not provided here. However, note that the hydraulic pressure control device PC regulates the extent of the opening of one or more regulating valves based on a signal pressure from a linear solenoid valve for hydraulic pressure regulation to regulate the amount of the hydraulic oil that is drained from the one or more regulating valves and to regulate the hydraulic pressure of the hydraulic oil to one or more specified pressures. The hydraulic oil regulated to the specified pressures is supplied to the respective friction engagement elements of the first engagement device CL1 and the second engagement device CL2, and the speed change mechanism TM, etc. at the respective required pressure levels.

3. Configuration of Control Device

Subsequently, the configurations of the control device 30 and the engine control device 31 that control the vehicular drive device 1 are explained with reference to FIG. 2.

The control units 32 to 34 in the control device 30 and the engine control device 31 each include, as a core member, an arithmetic processing device such as a CPU, etc., and include a storage device such as a RAM (random access memory) capable of reading and writing data from and into the arithmetic processing device, a ROM (read only memory) capable of reading data from the arithmetic processing device, etc. Respective function sections 41 to 47, etc. in the control device 30 are configured by software (program) stored in the ROM, etc. in the control device or separately provided hardware such as an arithmetic logic circuit, or both. The control units 32 to 34 in the control device 30 and the engine control device 31 are configured to communicate with each other, and share various kinds of information such as detected information of sensors and control parameters, etc. and perform cooperative control, to realize the functions of the respective function sections 41 to 47.

In addition, the vehicular drive device 1 includes sensors Se1 to Se3. Electric signals outputted from the respective sensors are inputted to the control device 30 and the engine control device 31. The control device 30 and the engine control device 31 calculate the detected information of the respective sensors based on the inputted electric signals.

The input rotational speed sensor Se1 is a sensor that detects the rotational speed of the input shaft I and the intermediate shaft M. The input shaft I and the intermediate shaft M are drivingly coupled to the rotor of the rotary electric machine MG in an integrated manner. Therefore, the rotary electric machine control unit 32 detects the rotational speed (angular speed) of the rotary electric machine MG and the rotational speed of the input shaft I and the intermediate shaft M based on the inputted signals of the input rotational speed sensor Se1. The output rotational speed sensor Se2 is a sensor that detects the rotational speed of the output shaft O. The power transmission control unit 33 detects the rotational speed (angular speed) of the output shaft O based on the inputted signals of the output rotational speed sensor Se2. In addition, the rotational speed of the output shaft O is proportional to the rotational speed of the wheels W and the vehicle speed. Therefore, the power transmission control unit 33 calculates the rotational speed of the wheels W and the vehicle speed based on the inputted signals of the output rotational speed sensor Se2. The engine rotational speed sensor Se3 is a sensor that detects the rotational speed of the engine output shaft Eo (engine E). The engine control device 31 detects the rotational speed (angular speed) of the engine E based on the inputted signals of the engine rotational speed sensor Se3.

3-1. Engine Control Device 31

The engine control device 31 includes an engine control section 41 that performs operation control for the engine E. In the present embodiment, in a case in which engine required torque is requested by the vehicle control unit 34, the engine control section 41 sets, as an output torque request value, the engine required torque requested by the vehicle control unit 34, and performs torque control that causes the engine E to output the torque of the output torque request value.

3-2. Power Transmission Control Unit 33

The power transmission control unit 33 includes a speed change mechanism control section 43 that performs control for the speed change mechanism TM, a first engagement device control section 44 that performs control for the first engagement device CL1, and a second engagement device control section 45 that performs control for the second engagement device CL2 during the start control of the engine E.

3-2-1. Speed Change Mechanism Control Section 43

The speed change mechanism control section 43 performs control that establishes each shift speed in the speed change mechanism TM. The speed change mechanism control section 43 determines a target shift speed in the speed change mechanism TM based on sensor detected information such as a vehicle speed, an extent of opening of an accelerator, a shift position, etc. The speed change mechanism control section 43 controls the hydraulic pressure that is supplied to a plurality of engagement devices provided in the speed change mechanism TM through the hydraulic pressure control device PC to engage or disengage the respective engagement devices and establish the target shift speed in the speed change mechanism TM. Specifically, the speed change mechanism control section 43 provides a request for a target hydraulic pressure (request pressure) for each engagement device to the hydraulic pressure control device PC. The hydraulic pressure control device PC supplies the hydraulic pressure of the requested target hydraulic pressure (request pressure) to each engagement device.

3-2-2. First Engagement Device Control Section 44

The first engagement device control section 44 controls the engagement state of the first engagement device CL1. In the present embodiment, the first engagement device control section 44 controls the hydraulic pressure that is supplied to the first engagement device CL1 through the hydraulic pressure control device PC so as to approach a first target torque capacity requested by the vehicle control unit 34. Specifically, the first engagement device control section 44 provides a request for a target hydraulic pressure (request pressure) that is set based on the first target torque capacity to the hydraulic pressure control device PC. The hydraulic pressure control device PC controls the hydraulic pressure such that the hydraulic pressure of the requested target hydraulic pressure (request pressure) is supplied to the first engagement device CL1.

3-2-3. Second Engagement Device Control Section 45

The second engagement device control section 45 controls the engagement state of the second engagement device CL2 during the start control of the engine E. In the present embodiment, the second engagement device control section 45 controls the hydraulic pressure that is supplied to the second engagement device CL2 through the hydraulic pressure control device PC such that the transmission torque capacity of the second engagement device CL2 approaches a second target torque capacity requested by the vehicle control unit 34. Specifically, the second engagement device control section 45 provides a request for a target hydraulic pressure (request pressure) that is set based on the second target torque capacity to the hydraulic pressure control device PC. The hydraulic pressure control device PC controls the hydraulic pressure such that hydraulic pressure of the requested target hydraulic pressure (request pressure) is supplied to the second engagement device CL2.

In the present embodiment, the second engagement device CL2 is one of a single or a plurality of engagement devices that establish each shift speed in the speed change mechanism TM. The engagement device of the speed change mechanism TM utilized as the second engagement device CL2 may be changed according to the established shift speed, or may be the same engagement device.

3-3. Rotary Electric Machine Control Unit 32

The rotary electric machine control unit 32 includes a rotary electric machine control section 42 that performs operation control for the rotary electric machine MG. In the present embodiment, when rotary electric machine required torque is requested by the vehicle control unit 34, the rotary electric machine control section 42 sets, as an output torque request value, rotary electric machine required torque requested by the vehicle control unit 34 and controls the rotary electric machine MG so as to output the torque of the output torque request value. Specifically, the rotary electric machine control section 42 controls output torque of the rotary electric machine MG through on-off control for a plurality of switching elements provided in the inverter.

3-4. Vehicle Control Unit 34

The vehicle control unit 34 includes a function section that performs control to integrate, as a whole vehicle, various kinds of torque control performed with respect to the engine E, the rotary electric machine MG, the speed change mechanism TM, the first engagement device CL1, the second engagement device CL2, etc., the engagement control for the respective engagement devices, etc.

The vehicle control unit 34 calculates, in accordance with the extent of opening of the accelerator, the vehicle speed, the amount of electric power stored in the battery, etc., torque required to drive the wheels W, that is, vehicle required torque that is a target driving force transmitted from the intermediate shaft M side to the output shaft O side, and determines a drive mode of the engine E and the rotary electric machine MG. The vehicle control unit 34 is a function section that performs integrated control by calculating the engine required torque that is output torque required of the engine E, the rotary electric machine required torque that is output torque required of the rotary electric machine MG, the first target torque capacity that is transmission torque capacity required of the first engagement device CL1, the second target torque capacity that is transmission torque capacity required of the second engagement device CL2, and providing requests for the calculated values to the other control units 32 and 33 and the engine control device 31.

In the present embodiment, the vehicle control unit 34 includes the first engagement slip control section 46, the temperature increase suppression control section 47, etc., and performs the temperature increase suppression control for the first engagement device CL1 during the first engagement slip control.

Hereinafter, the temperature increase suppression control is explained in detail.

3-4-1. Temperature Increase Suppression Control

The first engagement slip control section 46 is a function section that performs the first engagement slip control that, during rotation operation of the engine E, controls the second engagement device CL2 so as to be in the direct engaged state and controls the first engagement device CL1 so as to be in the slip engaged state.

The temperature increase suppression control section 47 is a function section that, in a case in which the temperature of the first engagement device CL1 increases during the first engagement slip control, causes the output torque of the rotary electric machine MG to increase and the transmission torque of the first engagement device CL1 to decrease.

Note that the temperature increase suppression control section 47 is configured to cause the transmission torque of the first engagement device CL1 to decrease to a value that is greater than zero, maintain the first engagement device CL1 so as to be in the slip engaged state, and transmit the driving force of the engine E to the wheels W side.

<Temperature Increase Suppression Control in a State in which the Rotation of the Wheels W has Stopped>

In the present embodiment, the temperature increase suppression control section 47 is configured to, in a case in which the temperature of the first engagement device CL1 exceeds a predetermined auxiliary threshold value in a state in which the rotation of the wheels W has stopped during the first engagement slip control, execute direct engagement maintaining control that causes the output torque of the rotary electric machine MG to increase and causes the transmission torque of the first engagement device CL1 to decrease while continuing to control the second engagement device CL2 so as to be in the direct engaged state. Note that the auxiliary threshold value corresponds to a “first threshold value,”

In the present embodiment, in causing the output torque of the rotary electric machine MG to increase and the transmission torque of the first engagement device CL1 to decrease in the direct engagement maintaining control, the temperature increase suppression control section 47 causes the output torque of the rotary electric machine MG to increase to an extent that an increase in the temperature of the rotary electric machine becomes within a predetermined allowable range in a state in which the rotation of the rotary electric machine MG has stopped and causes the transmission torque of the first engagement device CL1 to decrease in accordance with an amount of increase in the output torque of the rotary electric machine MG.

Alternatively, in a case in which the temperature of the first engagement device CL1 exceeds a predetermined slip threshold value that is greater than the auxiliary threshold value, the temperature increase suppression control section 47 executes, as the temperature increase suppression control, slip transition control that causes the second engagement device CL2 to transition from the direct engaged state to the slip engaged state and causes the rotational speed of the rotary electric machine MG to increase, and causes the output torque of the rotary electric machine MG to increase and the transmission torque of the first engagement device CL1 to decrease. Note that the slip threshold value corresponds to a “second threshold value.”

<Temperature Increase Suppression Control in a State in which the Wheels W are Rotating>

The temperature increase suppression control section 47 is configured to, in a case in which the temperature of the first engagement device CL1 increases in a state in which the wheels W are rotating during the first engagement slip control, execute, as the temperature increase suppression control, during-rotation control that causes the output torque of the rotary electric machine MG to increase and the transmission torque of the first engagement device CL1 to decrease while continuing to control the second engagement device CL2 so as to be in the direct engaged state.

In the present embodiment, the temperature increase suppression control section 47 is configured to, in a case in which the temperature of the first engagement device CL1 exceeds a predetermined rotation threshold value in a state in which the wheels W are rotating during the first engagement slip control, execute the during-rotation control.

3-4-1-1. Flow Chart

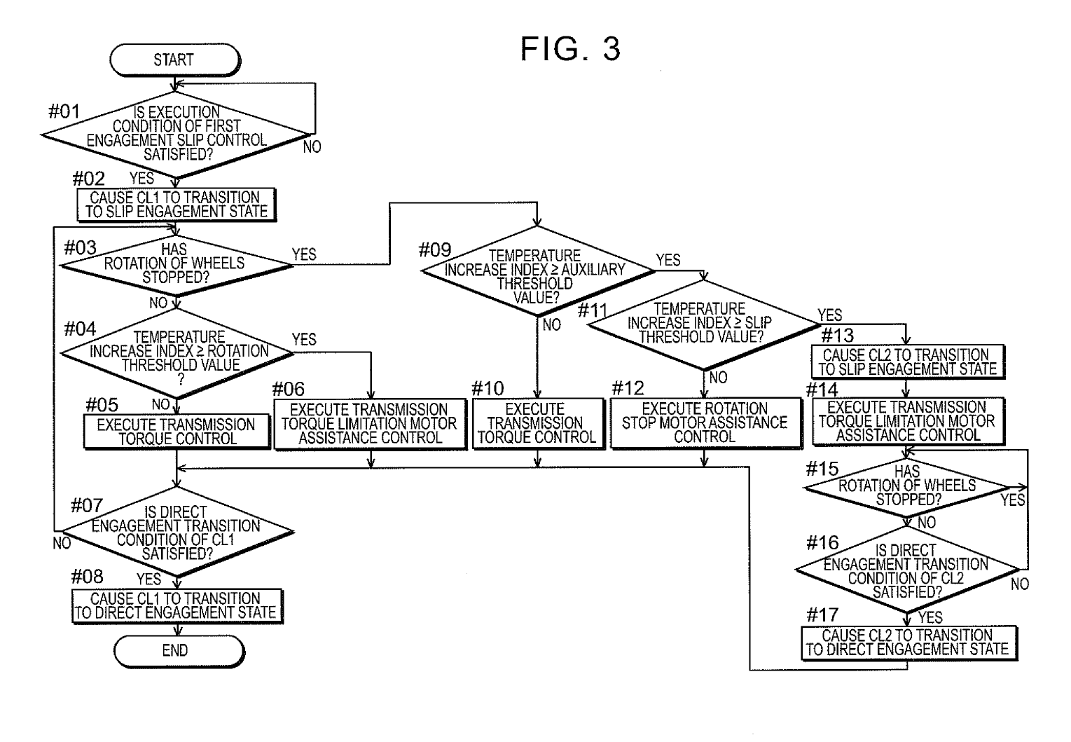

The temperature increase suppression control according to the present embodiment as described above may be configured, as indicated in the example of the flow chart in FIG. 3.

The first engagement slip control section 46 starts the first engagement slip control in a case in which execution condition for the first engagement slip control is satisfied (Step #01: Yes). The first engagement slip control is control that, in driving the wheels W by the driving force of the engine E, causes the first engagement device CL1 to be in the slip engaged state in order to transmit the output torque of the engine E to the wheels W side where the rotational speed is low, while maintaining the rotational speed of the engine E to be greater than or equal to the rotational speed at which the engine E can continue self-sustained operation.

In order to maintain the rotational speed of the engine E to be greater than or equal to the rotational speed at which the engine E can continue self-sustained operation in a state the rotational speed of the wheels W is low, it is only required to control either the first engagement device CL1 or the second engagement device CL2 so as to be in the slip engaged state. In the vehicular drive device 1 according to the present embodiment, the first engagement device CL1 has greater heat resistance and cooling capability against friction heat caused in the slip engaged state, compared to the second engagement device CL2. Therefore, the first engagement device CL1 is controlled by priority so as to be in the slip engaged state during the first engagement slip control. The first engagement device CL1 is provided especially to engage or disengage between the engine E and the rotary electric machine MG and the first engagement device CL1 is controlled so as to be in the slip engaged state during start control of the engine E. Therefore, the first engagement device CL1 is provided, which has greater heat resistance and cooling capability against friction heat caused in the slip engaged state, compared to the second engagement device CL2 that is one of a plurality of engagement devices provided in the speed change mechanism TM.

However, the heat resistance and the cooling capability of the first engagement device CL1 is limited. Therefore, it is necessary to suppress an increase in the temperature of the first engagement device CL1 through the temperature increase suppression control that is described later in a case in which the temperature of the first engagement device CL1 approaches an upper limit of an allowable range during execution of the first engagement slip control.

Execution condition for the first engagement slip control is satisfied, for example, when the rotational speed of the rotary electric machine MG or the output rotational speed is less than the rotational speed of the engine E and vehicle required torque becomes greater than zero during the rotation operation of the engine E. “During the rotation operation of the engine E” is a state in which the engine E is continuously rotating at the rotational speed that is greater than or equal to the rotational speed at which the engine E can continue self-sustained operation, typically, the engine E is combusting fuel. The output rotational speed is the rotational speed acquired by multiplying the rotational speed of the output shaft O by the speed ratio of the speed change mechanism TM.

In a case in which the execution condition for the first engagement slip control is satisfied (Step #01: Yes), the first engagement slip control section 46 causes the first engagement device CL1 to transition from the disengaged state or the direct engaged state to the slip engaged state (Step #02). Specifically, the first engagement slip control section 46 causes first target torque capacity (engagement pressure) of the first engagement device CL1 to increase from zero, or to decrease from full engagement capacity (full engagement pressure) to cause the first engagement device CL1 to transition to the slip engaged state. The full engagement capacity (full engagement pressure) is the transmission torque capacity (engagement pressure) at which the engagement state without slip can be maintained even in a case in which the torque that is transmitted from the driving force source to the engagement device fluctuates.

In the present embodiment, the first engagement slip control section 46 is configured to cause the first target torque capacity to increase or decrease up to a value corresponding to the vehicle required torque and control the torque that is transmitted to the wheels W side in a state in which the first engagement device CL1 is in the slip engaged state so as to be the torque corresponding to the vehicle required torque.

<Rotation Stop Determination of Wheels W>

The temperature increase suppression control section 47, after the first engagement device CL1 transitions to the slip engaged state, determines whether the rotation of the wheels W has stopped (Step #03),

In the present embodiment, the temperature increase suppression control section 47 is configured to determine that the rotation of the wheels W has stopped in a case in which the rotational speed (vehicle speed) of the output shaft O or the rotational speed of the rotary electric machine MG is within a predetermined range (referred to as stop determination range) including zero. The stop determination range here is set in accordance with the rotational speed at which the increase in the temperature of the rotary electric machine MG is within the allowable range even in a case in which the rotary electric machine MG is caused to output a maximum torque. This is because, when causing the rotary electric machine MG to output torque while the rotation of the rotary electric machine MG has stopped, the coil in which a current flows does not switch in accordance with the rotation and a current continues to flow in a part of the coil. Thereby, heat generation is concentrated at a part of the coil and a part of a switching elements, which may cause the increase in the temperature of the part of the coil and the part of the switching elements to exceed the allowable range. In addition, even in a case in which the rotational speed of the rotary electric machine MG slightly increases from zero, the concentrated heat generation at the coil and the switching elements is not sufficiently solved. Therefore, the temperature increase suppression control section 47 is configured to, in a case in which the rotational speed becomes equal to or greater than the rotational speed at which the concentrated heat generation is sufficiently solved, determine that the rotation of the wheels W has not stopped. In addition, the temperature increase suppression control section 47 may be configured to, in a case in which a state in which the rotational speed of the output shaft O or the rotary electric machine MG is out of the stop determination range continues for a predetermined time, determine that the rotation of the wheels W has not stopped. It is possible to wait until the rotational speed of the output shaft O or the rotary electric machine MG becomes within the stop determination range in which the increase in the temperature of the rotary electric machine MG is stably within the allowable range and determine the rotation stop of the wheels W.

<Calculation of Temperature of First Engagement Device CL1>

The temperature increase suppression control section 47 is configured to calculate the temperature of the first engagement device CL1 as a temperature increase index.

The amount of heat generation due to friction between the engagement members in a case in which the friction engagement element is in the slip engaged state is in proportion to a value acquired by multiplying transmission torque that transmits between the engagement members by rotational speed difference between the engagement members. The engagement members of the friction engagement element include heat capacity. The temperature of the engagement members changes with delay with respect to an increase or a decrease of the heat generation amount. In addition, the friction engagement element is provided with a cooling mechanism and the temperature of the engagement members changes in accordance with deviation between the amount of heat generation and the amount of heat radiation by the cooling mechanism. The amount of heat radiation by the cooling mechanism changes in accordance with the temperature of the engagement members. In a case in which the cooling mechanism utilizes cooling medium such as oil, the amount of heat radiation by the cooling mechanism changes also depending on the temperature of the cooling medium.

In the present embodiment, the temperature increase suppression control section 47 is configured to estimate the temperature of the engagement members of the first engagement device CL1 by performing processing for response lag due to heat capacity and heat radiation based on the amount of heat generation due to friction in the first engagement device CL1.

Specifically, the temperature increase suppression control section 47 calculates, as the amount of heat generation in the first engagement device CL1, a value acquired by multiplying the transmission torque capacity (transmission torque) of the first engagement device CL1 by the rotational speed difference between engagement members of the first engagement device CL1. In addition, the temperature increase suppression control section 47 calculates the amount of heat radiation from the engagement members of the first engagement device CL1 based on the temperature of the first engagement device CL1. In such event, a characteristic map storing a relational characteristic between the temperature of the first engagement device CL1 and the amount of heat generation is utilized. To calculate the amount of heat generation, oil temperature detected by an oil temperature sensor or estimated oil temperature may be utilized. The amount of heat acquired by subtracting the amount of heat radiation from the amount of heat generation of the first engagement device CL1 is divided by the heat capacity, and integrated. The integrated value is estimated as the temperature of the engagement members of the first engagement device CL1.

Alternatively, the temperature increase suppression control section 47 calculates a steady temperature of the first engagement device CL1 based on the amount of heat generation of the first engagement device CL1 using the characteristic map that previously stores characteristics of the amount of heat generation of first engagement device CL1 in the steady state and the temperature of the engagement members of the first engagement device CL1. A value acquired by performing processing for response lag such as first order lag due to heat capacity and heat radiation with respect to the steady temperature of the first engagement device CL1 may be estimated as the temperature of the engagement members of the first engagement device CL1.

Alternatively, in a case in which a temperature sensor for measuring the temperature of the engagement members is provided in the first engagement device CL1, the temperature increase suppression control section 47 may be configured to detect the temperature of first engagement device CL1 based on output signals of the temperature sensor.

<During Rotation of Wheels W>

The temperature increase suppression control section 47, in a case in which it is determined that the wheels W are rotating, determines whether the temperature of the first engagement device CL1 has exceeded a predetermined rotational threshold value (Step #04). The rotational threshold value here is set to a value equal to or less than an allowable upper limit temperature that is defined by heat resistance.

In a case in which the temperature increase suppression control section 47 determines that the temperature of the first engagement device CL1 does not exceed the rotational threshold value (Step #04: No), the temperature increase suppression control section 47 does not perform the temperature increase suppression control and executes transmission torque control that controls the transmission torque (transmission torque capacity) of the first engagement device CL1 in accordance with the vehicle required torque (Step #05).

On the other hand, in a case in which the temperature increase suppression control section 47 determines that the temperature of the first engagement device CL1 has exceeded the rotational threshold value (Step #04: Yes), the temperature increase suppression control section 47 executes, as the during-rotation control, transmission torque limitation motor assistance control that causes the transmission torque of the first engagement device CL1 to decrease and the output torque of the rotary electric machine MG to increase (Step #06). Thereby, an increase in the temperature of the first engagement device CL1 is suppressed.

After Step #05 or #06, the temperature increase suppression control section 47 determines whether a direct transition condition that causes the first engagement device CL1 to transition from the slip engaged state to the direct engaged state is satisfied (Step #07). In a case in which the direct transition condition is not satisfied (Step #07: No), the temperature increase suppression control section 47 returns to Step #03 and repeats the processing. In the present embodiment, the temperature increase suppression control section 47 is configured to determine that the direct transition condition for the first engagement device CL1 is satisfied in a case in which the rotational speed difference Δω1 between the engagement members of the first engagement device CL1 becomes equal to or less than a specified value that is previously determined.

<During Rotation Stop of Wheels W>

On the other hand, in a case in which the temperature increase suppression control section 47 determines that the rotation of the wheel W has stopped (Step #03: Yes), the temperature increase suppression control section 47 determines whether the temperature of the first engagement device CL1 exceeds a predetermined auxiliary threshold value (Step #09). The auxiliary threshold value here is set to a value less than the slip threshold value.

In a case in which the temperature increase suppression control section 47 determines that the temperature of the first engagement device CL1 does not exceed the auxiliary threshold value (Step #09: No), the temperature increase suppression control section 47 does not perform the temperature increase suppression control and executes the transmission torque control that controls the transmission torque (transmission torque capacity) of the first engagement device CL1 in accordance with the vehicle required torque (Step #10).

On the other hand, in a case in which the temperature increase suppression control section 47 determines that the temperature of the first engagement device CL1 has exceeded the auxiliary threshold value (Step #09: Yes), the temperature increase suppression control section 47 determines whether the temperature of the first engagement device CL1 has exceeded the slip threshold value that is previously determined (Step #11). The slip threshold value here is set to a value equal to or less than an allowable upper limit temperature that is defined by heat resistance.

In a case in which the temperature increase suppression control section 47 determines that the temperature of the first engagement device CL1 has exceeded the auxiliary threshold value (Step #09: Yes) and does not exceed the slip threshold value (Step #11: No), the temperature increase suppression control section 47 executes, as the direct engagement maintaining control, rotation stop motor assistance control that causes the output torque of the rotary electric machine MG to increase and causes the transmission torque of the first engagement device CL1 to decrease while continuing to control the second engagement device CL2 so as to be in the direct engaged state (Step #12). Even in a case in which the rotation of the rotary electric machine MG stops and the heat generation is concentrated at a part of the coil and a part of a switching elements of the rotary electric machine MG, it is possible to cause the output torque of the rotary electric machine MG to increase to the extent that an increase in the temperature of the rotary electric machine MG becomes within the allowable range. It is possible to cause the transmission torque of the first engagement device CL1 to decrease and suppress the increase in the temperature of the first engagement device CL1.

After Step #10 or #12, in a case in which the direct transition condition for the first engagement device CL1 is not satisfied (Step #07: No), the temperature increase suppression control section 47 returns to Step #03 and repeats the processing.

On the other hand, in a case in which the temperature increase suppression control section 47 determines that the temperature of the first engagement device CL1 has exceeded the auxiliary threshold value (Step #09: Yes) and has exceeded the slip threshold value (Step #11: Yes), the temperature increase suppression control section 47 causes the second engagement device CL2 to transition from the direct engaged state to the slip engaged state and causes the rotational speed of the rotary electric machine MG to increase as the slip transition control (Step #13), and executes the transmission torque limitation motor assistance control that causes the transmission torque of the first engagement device CL1 to decrease and the output torque of the rotary electric machine MG to increase (Step #14).

During execution of the transmission torque limitation motor assistance control, in a case in which the temperature increase suppression control section 47 determines that the wheels W are rotating (Step #15: No), the temperature increase suppression control section 47 determines whether a direct engagement transition condition that causes the second engagement device CL2 to transition from the slip engaged state to the direct engaged state is satisfied (Step #16). In a case in which the direct engagement transition condition is satisfied (Step #16: Yes), the temperature increase suppression control section 47 causes the second engagement device CL2 to transition from the slip engaged state to the direct engaged state (Step #17). On the other hand, in a case in which the temperature increase suppression control section 47 determines that the rotation of the wheels W has stopped (Step #15: Yes), or in a case in which the direct engagement transition condition for the second engagement device CL2 is not satisfied (Step #16: No), the temperature increase suppression control section 47 returns to Step #15 and repeats the processing. In the present embodiment, the temperature increase suppression control section 47 is configured to determine that the direct engagement transition condition for the second engagement device CL2 is satisfied in a case in which the rotational speed difference between the engagement members of the second engagement device CL2 becomes equal to or less than a specified value that is previously determined.

After the temperature increase suppression control section 47 causes the second engagement device CL2 to transition to the direct engaged state at Step #17, in a case in which the direct engagement transition condition for the first engagement device CL1 is not satisfied (Step #07: No), the temperature increase suppression control section 47 returns to Step #03 and repeats the processing.

In a case in which the direct engagement transition condition for the first engagement device CL1 is satisfied (Step #07: Yes), the temperature increase suppression control section 47 causes the first engagement device CL1 to transition from the slip engaged state to the direct engaged state (Step #08) and terminates the first engagement slip control and the temperature increase suppression control.

3-4-1-2. Timing Chart in a Case in which the Rotation of the Wheels W has Stopped

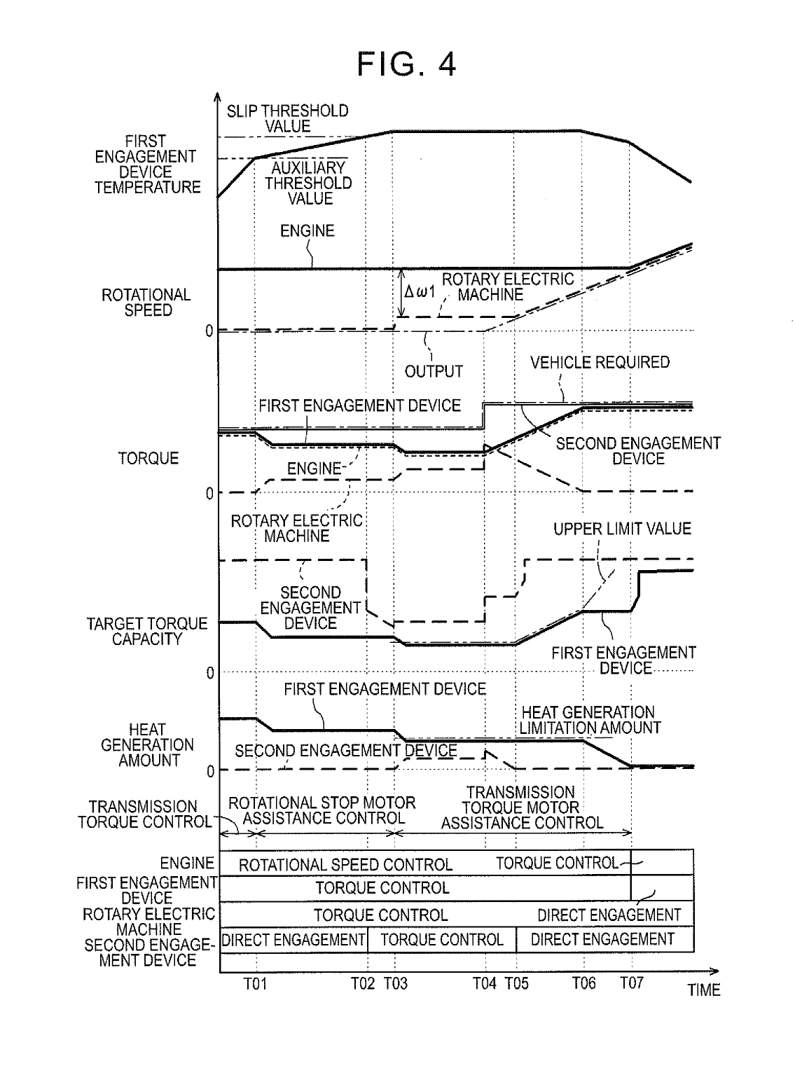

Subsequently, on the basis of an example of a timing chart shown in FIG. 4, in a case in which it is determined that the rotation of the wheels W has stopped (Step #03: Yes), a case in which the temperature of the first engagement device CL1 exceeds the auxiliary threshold value and thereafter the slip threshold value (Step #09: Yes, Step #11: Yes) is explained.

In the example shown in FIG. 4, up to time T01, the first engagement device CL1 has been caused to transition to the slip engaged state and the first engagement slip control has started. In addition, the vehicle required torque has been caused to increase and the transmission torque of the first engagement device CL1 in accordance with the vehicle required torque is transmitted to the wheels W side. However, in the example shown in FIG. 4, a vehicle is located at an uphill road, uphill resistance torque acting on the wheels W due to the vehicle weight at the uphill road equilibrates with the torque in accordance with the vehicle required torque and the rotation of the wheels W has stopped. In addition, in the example shown in FIG. 4, the inclination of uphill is large and the vehicle required torque is large. The amount of the heat generation of the first engagement device CL1 is large. Therefore, the temperature of the engagement members of the first engagement device CL1 is rapidly increasing. The amount of the heat generation of the first engagement device CL1 is, in a steady state, the amount of the heat generation with which the temperature of the first engagement device CL1 exceeds the allowable range. However, the temperature of the first engagement device CL1 is increasing with delay due to heat capacity, etc.

Up to time T01, the temperature increase suppression control section 47 determines that the rotation of the wheels W has stopped and the temperature of the first engagement device CL1 does not exceed the auxiliary threshold value. Therefore, the temperature increase suppression control section 47 executes the transmission torque control that controls the transmission torque (transmission torque capacity) of the first engagement device CL1 in accordance with the vehicle required torque. Thus, a first target torque capacity of the first engagement device CL1 is set to a value in accordance with the vehicle required torque. In addition, the engine required torque of the engine E is also set to a value in accordance with the vehicle required torque. In the present embodiment, the engine required torque is configured to be changed by rotational speed control for the engine E that maintains the rotational speed of the engine E so as to be a predetermined rotational speed. The first target torque capacity may be configured to be changed by the rotational speed control for the engine E. In addition, the rotary electric machine required torque of the rotary electric machine MG is set to a value around zero. A second target torque capacity of the second engagement device CL2 is set to a full engagement capacity (full engagement pressure) and the second engagement device CL2 is controlled so as to be in the direct engaged state.

At time T02, the temperature increase suppression control section 47 determines that the temperature of the first engagement device CL1 has exceeded the auxiliary threshold value. The temperature increase suppression control section 47 terminates the transmission torque control and starts the execution of the rotation stop motor assistance control that causes the output torque of the rotary electric machine MG to increase and the transmission torque of the first engagement device CL1 to decrease.

In the present embodiment, the temperature increase suppression control section 47 is configured to cause the transmission torque of the first engagement device CL1 to decrease in accordance with the amount of increase in the output torque of the rotary electric machine MG.

The temperature increase suppression control section 47 is configured to, as the rotation stop motor assistance control, cause the output torque of the rotary electric machine MG to increase to the extent that the increase in the temperature of the rotary electric machine MG becomes within the allowable range that is previously determined in a state in which the rotation of the rotary electric machine MG has stopped and cause the transmission torque of the first engagement device CL1 to decrease in accordance with the amount of increase in the output torque of the rotary electric machine MG.

The temperature increase suppression control section 47, even in a case in which the rotation of the rotary electric machine MG has stopped, causes the rotary electric machine required torque of the rotary electric machine MG to increase up to a rotation stop allowable torque that is previously determined such that the increase in the temperature of the rotary electric machine MG becomes within the allowable range (from time T01 to time T02). On the other hand, the temperature increase suppression control section 47 causes the first target torque capacity of the first engagement device CL1 to decrease in accordance with the rotation stop allowable torque. In addition, the temperature increase suppression control section 47 causes the engine required torque of the engine E to decrease in accordance with the rotation stop allowable torque.

By causing the transmission torque of the first engagement device CL1 to decrease in accordance with the rotation stop allowable torque, the amount of heat generation of the first engagement device CL1 that is defined by a value acquired by multiplying the transmission torque of the first engagement device CL1 by the rotational speed difference Δω1 between the engagement members of the first engagement device CL1 decreases. However, in the example shown in FIG. 4, the vehicle required torque is large. Therefore, it is not possible to cause the rotary electric machine required torque of the rotary electric machine MG to increase until the increase in the temperature (temperature increase index) of the first engagement device CL1 can be sufficiently suppressed. However, a ratio of temperature increase can be decreased.

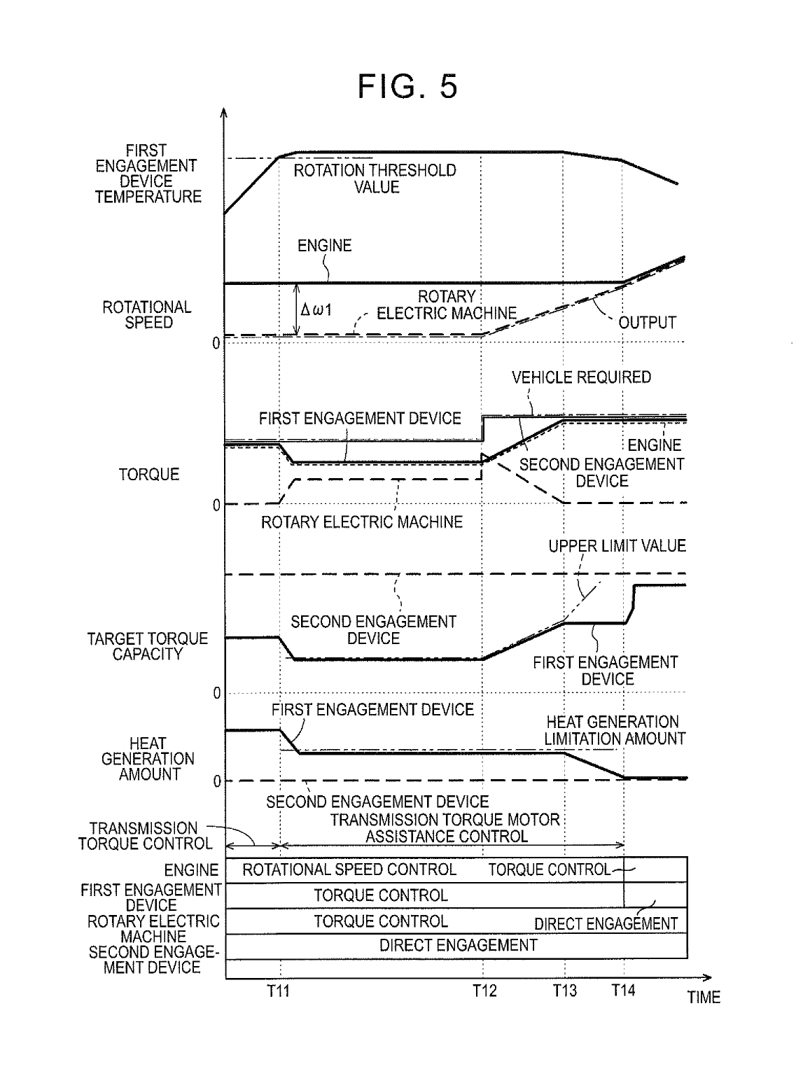

At time T02, the temperature increase suppression control section 47 determines that the temperature of the first engagement device CL1 has exceeded the slip threshold value. The temperature increase suppression control section 47 starts transition control that causes the second engagement device CL2 to transition from the direct engaged state to the slip engaged state. In the present embodiment, the temperature increase suppression control section 47 is configured to cause the second target torque capacity of the second engagement device CL2 to decrease from the full engagement capacity to a value equal to or less than the transmission torque capacity that corresponds to the vehicle required torque and cause the second engagement device CL2 to transition to the slip engaged state. In the example shown in FIG. 4, the temperature increase suppression control section 47 causes the second target torque capacity of the second engagement device CL2 to decrease from the full engagement capacity in a stepped manner, and thereafter gradually decrease (from time T02 to T03). In a case in which the temperature increase suppression control section 47 determines that the rotational speed difference between the engagement members of the second engagement device CL2 is generated (time T03), the temperature increase suppression control section 47 terminates the decrease of the second target torque capacity and sets as the second target torque capacity a value of the transmission torque capacity with which the second engagement device CL2 is able to transmit the torque in accordance with the vehicle required torque from the rotary electric machine MG side to the wheels W side (from time T03 to T05). FIGS. 4 and 5 show the transmission torque of the second engagement device CL2 and the second target torque capacity with values that correspond to the transmission torque and the transmission torque capacity that acts on the intermediate shaft M, that is, the values that are converted using the intermediate shaft M as a reference.

After the second engagement device CL2 transitions to the slip engaged state, the temperature increase suppression control section 47 starts execution of the rotational speed control that controls the rotational speed of the rotary electric machine MG so as to be a specified target rotational speed that is greater than zero (time T03). The target rotational speed is set to a rotational speed at which concentrated heat generation of the coil and the switching elements can be suppressed. In the present embodiment, the rotary electric machine required torque is configured to be changed by the rotational speed control.

After the temperature increase suppression control section 47 causes the second engagement device CL2 to transition to the slip engaged state and causes the rotational speed of the rotary electric machine MG to increase, the temperature increase suppression control section 47 terminates the rotational stop motor assistance control and starts execution of the transmission torque limitation motor assistance control that causes the transmission torque of the first engagement device CL1 to decrease and causes the output torque of the rotary electric machine MG to increase (time T03).

In the present embodiment, the temperature increase suppression control section 47 is configured to cause the transmission torque of the first engagement device CL1 to decrease in accordance with the amount of increase in the output torque of the rotary electric machine MG.

The temperature increase suppression control section 47 is configured to, as the transmission torque limitation motor assistance control, cause the transmission torque of the first engagement device CL1 to decrease such that the increase in the temperature of the first engagement device CL1 becomes within the allowable range that is previously determined and cause the output torque of the rotary electric machine MG to increase in accordance with the amount of decrease in the transmission torque of the first engagement device CL1.

In the present embodiment, the temperature increase suppression control section 47 is configured to acquire an upper limit value of the transmission torque of the first engagement device CL1 on the basis of a heat generation limit amount that is the amount of heat generation of the first engagement device CL1, which is previously set such that the increase in the temperature of the first engagement device CL1 becomes within the allowable range in the steady state, cause the transmission torque of the first engagement device CL1 to decrease down to the upper limit value and cause the output torque of the rotary electric machine MG to increase in accordance with the amount of decrease in the transmission torque of the first engagement device CL1.

Specifically, the temperature increase suppression control section 47 sets as the upper limit value, a value acquired by dividing the heat generation limit amount of the first engagement device CL1 that is previously set such that the increase in the temperature of the first engagement device CL1 becomes within the allowable range in the steady state by the rotational speed difference Δω1 between the engagement members of the first engagement device CL1. The temperature increase suppression control section 47 sets, as the first target torque capacity of the first engagement device CL1, a value acquired by limiting a value that is set in accordance with the vehicle required torque to the upper limit value. The temperature increase suppression control section 47 causes the rotary electric machine required torque to increase in accordance with the amount of decrease in the first target torque capacity that is acquired by limiting a value that is set in accordance with the vehicle required torque to the upper limit value.

The amount of heat generation of the first engagement device CL1 is reduced to the heat generation limit amount. Therefore, the increase in the temperature (temperature increase index) of the first engagement device CL1 is suppressed within the allowable range.

In the present embodiment, the heat generation limit amount of the first engagement device CL1 is previously set such that the increase in the temperature of the first engagement device CL1 is within the allowable range that is set on the basis of the slip threshold value, in the steady state. For example, the heat generation limit amount of the first engagement device CL1 is set such that the temperature of the first engagement device CL1 becomes the slip threshold value in the steady state.

The heat generation limit amount of the first engagement device CL1 is set to a value that is greater than zero. Therefore, the upper limit value of the transmission torque of the first engagement device CL1 is set to a value that is greater than zero. Thereby, the transmission torque of the first engagement device CL1 is caused to decrease to a value that is greater than zero.

At time T04, the vehicle required torque increases due to an increase in the extent of opening of the accelerator, etc. The first target torque capacity of the first engagement device CL1 is limited to the upper limit value. Therefore, the rotary electric machine required torque is caused to increase in accordance with the increase in the vehicle required torque. Driving torque that is transmitted to the wheels W exceeds uphill resistance torque due to the increase in the vehicle required torque and the vehicle speed starts to increase (subsequent to time T04).

Along with the increase in the vehicle speed, the rotational speed difference Δω1 of the first engagement device CL1 decreases and the upper limit value that is calculated by dividing the heat generation limit amount by the rotational speed difference Δω1 increases. Along with the increase in the upper limit value, the first target torque capacity increases (from time T05 to T06). When the upper limit value increases and exceeds a value that is set in accordance with the vehicle required torque, the first target torque capacity is not limited to the upper limit and set to a value that corresponds to the vehicle required torque (time T06 to T07). In addition, the output torque of the engine E is caused to increase in accordance with the increase in the first target torque capacity. Along with the increase in the upper limit value, with respect to the value that corresponds to the vehicle required torque, the amount of decrease in the first target torque capacity decreases and the amount of increase in the rotary electric machine required torque decreases (from time T05 to T06). In a case in which the rotational speed difference Δω1 of the first engagement device CL1 decreases, the transmission torque of the first engagement device CL1 and the output torque of the engine E are caused to increase and the output torque of the rotary electric machine MG is caused to decrease while maintaining the increase in the temperature of the first engagement device CL1 so as to be within the allowable range. Therefore, it is possible to suppress consumption of charged electricity of the battery by the output torque of the rotary electric machine MG and drive the wheels W with the output torque of the engine E, thereby fuel consumption can be improved.

The rotational speed of the output shaft O increases in proportion to the increase in the vehicle speed. FIG. 4 shows an output rotational speed that is a rotational speed acquired by multiplying the rotational speed of the output shaft O by a speed ratio of the speed change mechanism TM.

In the present embodiment, the temperature increase suppression control section 47 determines that a direct engagement transition condition for the second engagement device CL2 is satisfied in a case in which the rotational speed difference between the rotational speed of the rotary electric machine MG and the output rotational speed, which corresponds to the rotational speed difference between the engagement members of the second engagement device CL2, becomes equal to or less than a specified value that is previously determined (time T05). The temperature increase suppression control section 47 causes the second target torque capacity of the second engagement device CL2 to increase up to the full engagement capacity to cause the second engagement device CL2 to transition to the direct engaged state.

In a case in which the vehicle speed further increases and the rotational speed difference Δω1 between the engagement members of the first engagement device CL1 becomes equal to or less than a specified value that is previously determined, the temperature increase suppression control section 47 determines that the direct engagement transition condition for the first engagement device CL1 is satisfied (time T07). The temperature increase suppression control section 47 causes the first target torque capacity of the first engagement device CL1 to increase up to the full engagement capacity to cause the first engagement device CL1 to transition to the direct engaged state and terminates the first engagement slip control and the temperature increase suppression control.

3-4-1-3. Timing Chart in a Case in which the Wheels W are Rotating

Subsequently, on the basis of an example of a timing chart shown in FIG. 5, in a case in which it is determined that the rotation of the wheels W has not stopped (Step #03: NO), a case in which the temperature of the first engagement device CL1 exceeds the rotation threshold value (Step #04: Yes) is explained.

Also in the example shown in FIG. 5, in the same manner as the example shown in FIG. 4, up to time T11, the first engagement device CL1 has been caused to transition to the slip engaged state and the first engagement slip control has started. However, in the example shown in FIG. 5, although the vehicle is located at an uphill road, the driving torque that is transmitted to the wheels W in accordance with the vehicle required torque slightly exceeds the uphill resistance torque and the vehicle is traveling at a very slow speed.

Up to time T11, the temperature increase suppression control section 47 determines that the rotation of the wheels W has not stopped and the temperature of the first engagement device CL1 does not exceed the rotation threshold value. Therefore, the temperature increase suppression control section 47 executes the transmission torque control that controls the transmission torque (transmission torque capacity) of the first engagement device CL1 in accordance with the vehicle required torque. Thus, the first target torque capacity of the first engagement device CL1 and the engine required torque of the engine E are set to values that correspond to the vehicle required torque. In addition, the rotary electric machine required torque of the rotary electric machine MG is set to a value around zero. The second target torque capacity of the second engagement device CL2 is set to the full engagement capacity (full engagement pressure) and the second engagement device CL2 is controlled so as to be in the direct engaged state.

At time T11, the temperature increase suppression control section 47 determines that the temperature of the first engagement device CL1 has exceeded the rotation threshold value. The temperature increase suppression control section 47 terminates the transmission torque control and starts execution of the transmission torque limitation motor assistance control that causes the transmission torque of the first engagement device CL1 to decrease and the output torque of the rotary electric machine MG to increase (time T11).

In the present embodiment, the temperature increase suppression control section 47 is configured to cause the transmission torque of the first engagement device CL1 to decrease in accordance with the amount of increase in the output torque of the rotary electric machine MG.

The temperature increase suppression control section 47 is configured to, as the transmission torque limitation motor assistance control, in the same manner as the case explained using FIG. 4, cause the transmission torque of the first engagement device CL1 to decrease such that the increase in the temperature of the first engagement device CL1 becomes within the allowable range that is previously determined and cause the output torque of the rotary electric machine MG to increase in accordance with the amount of decrease in the transmission torque of the first engagement device CL1.

Specifically, the temperature increase suppression control section 47 is configured to calculate the upper limit value of the transmission torque of the first engagement device CL1 on the basis of the heat generation limit amount that is the amount of heat generation of the first engagement device CL1 that is previously set such that the increase in the temperature of the first engagement device CL1 becomes within the allowable range in the steady state, cause the transmission torque of the first engagement device CL1 to decrease down to the upper limit value, and cause the output torque of the rotary electric machine MG to increase in accordance with the amount of decrease in the transmission torque of the first engagement device CL1.

In the present embodiment, the heat generation limit amount of the first engagement device CL1 is previously set such that the increase in the temperature of the first engagement device CL1 becomes within the allowable range that is set on the basis of the rotation threshold value, in the steady state. For example, the heat generation limit amount of the first engagement device CL1 is set such that the temperature of the first engagement device CL1 becomes the rotation threshold value in the steady state.

In the same manner as the case explained using FIG. 4, the amount of heat generation of the first engagement device CL1 is reduced down to the heat generation limit amount. Therefore, the increase in the temperature (temperature increase index) of the first engagement device CL1 is suppressed within the allowable range.

At time T12, the vehicle required torque increases due to an increase in the extent of opening of the accelerator, etc. The first target torque capacity of the first engagement device CL1 is limited to the upper limit value. Therefore, the rotary electric machine required torque is caused to increase in accordance with the increase in the vehicle required torque.

Due to the increase in the vehicle required torque, the vehicle speed starts to further increase (subsequent to time T12).

Along with the increase in the vehicle speed, the rotational speed difference Δω1 of the first engagement device CL1 decreases, and the upper limit value that is calculated by dividing the heat generation limit amount by the rotational speed difference Δω1 increases. Along with the increase in the upper limit value, the first target torque capacity increases (from time T12 to T13). When the upper limit value increases and exceeds a value that is set in accordance with the vehicle required torque, the first target torque capacity is not limited to the upper limit and set to a value that corresponds to the vehicle required torque (time T13 to T14).

Along with the increase in the upper limit value, with respect to the value that corresponds to the vehicle required torque, the amount of decrease in the first target torque capacity decreases and the amount of increase in the rotary electric machine required torque decreases (from time T12 to T13).

The temperature increase suppression control section 47 determines that the direct engagement transition condition for the first engagement device CL1 is satisfied in a case in which the vehicle speed increases and the rotational speed difference Δω1 between the engagement members of the first engagement device CL1 becomes equal to or less than a specified value that is previously determined (time T14). The temperature increase suppression control section 47 causes the first target torque capacity of the first engagement device CL1 to increase up to the full engagement capacity, causes the first engagement device CL1 to transition to the direct engaged state, and terminates the first engagement slip control and the temperature increase suppression control.

### OTHER EMBODIMENTS

Lastly, other embodiments are explained. A configuration disclosed in each of the embodiments described below is not limited to be applied separately. The configuration may be applied in combination with a configuration disclosed in any other embodiment unless any contradiction occurs.

(1) In the present embodiment described above, a case is exemplified, in which, after the wheels W start to rotate in a state in which the second engagement device CL2 is in the slip engaged state, the temperature increase suppression control section 47 causes the second engagement device CL2 to transition from the slip engaged state to the direct engaged state, and thereafter, causes the first engagement device CL1 to transition from the slip engaged state to the direct engaged state. However, embodiments are not limited thereto. Specifically, the temperature increase suppression control section 47 may be configured to, after the wheels W start to rotate in a state in which the second engagement device CL2 is in the slip engaged state, cause the first engagement device CL1 to transition from the slip engaged state to the direct engaged state, and thereafter, cause the second engagement device CL2 to transition from the slip engaged state to the direct engaged state. With such a configuration, even if the torque shock occurs when the first engagement device CL1 transitions to the direct engaged state, it is possible to prevent the torque shock from being transmitted to the wheels W because the second engagement device CL2 is in the slip engaged state.

<Flow Chart>

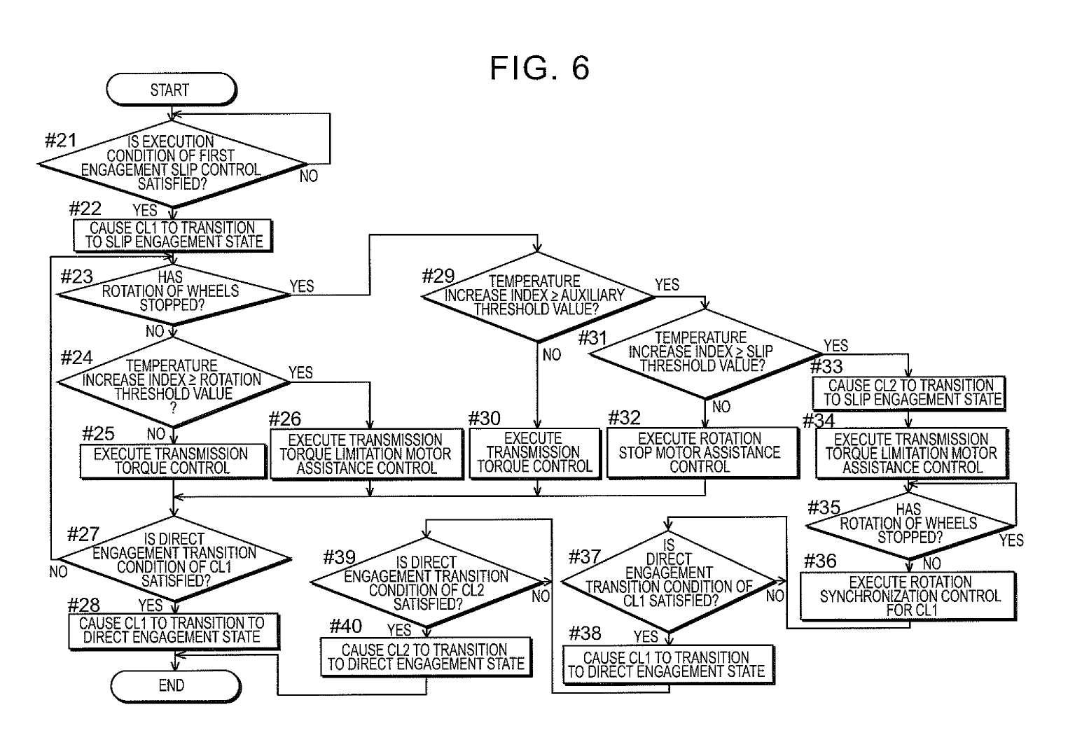

In such a case, the flow chart shown in FIG. 3 changes to the flow chart shown in FIG. 6. Step #21 to Step #35 shown in FIG. 6 is the same as Step #01 to Step #15 shown in FIG. 4. Therefore, the explanation is not given.

In a case in which the temperature increase suppression control section 47 determines that the wheels W are rotating during execution of the transmission torque limitation motor assistance control (Step #35: No), the temperature increase suppression control section 47 starts execution of rotation synchronization control that causes the rotational speed difference Δω1 between the engagement members of the first engagement device CL1 to decrease and the first engagement device CL1 to rotationally synchronize (step #36).

The temperature increase suppression control section 47 determines whether the direct engagement transition condition to cause the first engagement device CL1 to transition from the slip engaged state to the direct engaged state is satisfied (Step #37). In a case in which the engagement state transition condition is satisfied (Step #37: Yes), the temperature increase suppression control section 47 causes the first engagement device CL1 to transition from the slip engaged state to the direct engaged state (Step #38).

The temperature increase suppression control section 47 determines whether the direct engagement transition condition to cause the second engagement device CL2 to transition from the slip engaged state to the direct engaged state is satisfied (Step #39). In a case in which the direct engagement transition condition is satisfied (Step #39: Yes), the temperature increase suppression control section 47 causes the second engagement device CL2 to transition from the slip engaged state to the direct engaged state (Step #40), and terminates the first engagement slip control and the temperature increase suppression control.

<Timing Chart>

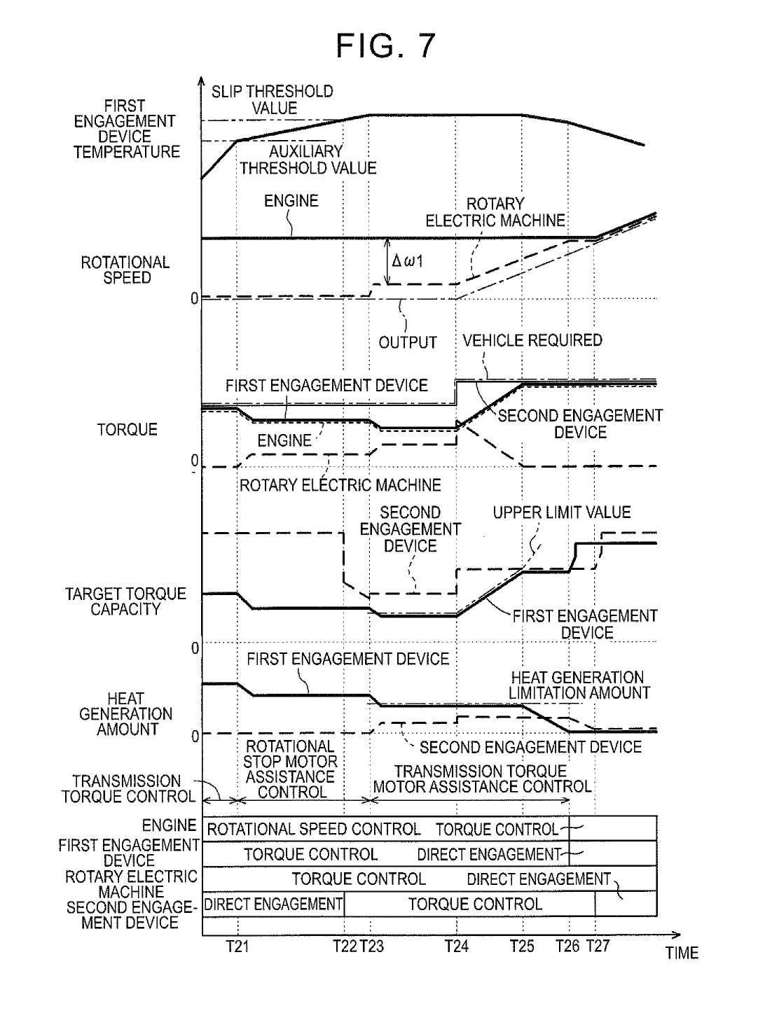

In such a case, the example of the timing chart shown in FIG. 4 changes to the example of the timing chart shown in FIG. 7. The section up to time T24 shown in FIG. 7 is the same as the section up to time T04 shown in FIG. 4. Therefore, the explanation is not given.

At time T24, when the vehicle required torque increases and the vehicle speed starts to increase, the temperature increase suppression control section 47 determines that the wheels W are rotating and starts execution of rotation synchronization control for the first engagement device CL1. In the example shown in FIG. 7, in order to suppress an increase in the amount of heat generation of the second engagement device CL2, the temperature increase suppression control section 47 is configured to maintain the rotational speed difference of the second engagement device CL2 so as to be a specified value that is previously determined and cause the first engagement device CL1 to rotationally synchronize. Specifically, the temperature increase suppression control section 47 sets, as the target rotational speed of the rotary electric machine MG, a value acquired by adding a specified rotational speed to an output rotational speed given by multiplying the rotational speed of the output shaft O by the speed ratio of the speed change mechanism TM. The temperature increase suppression control section 47 continues the rotational speed control that controls the rotational speed of the rotary electric machine MG so as to be the target rotational speed (from time T24 to T26). Thereby, it is possible to cause the rotational speed of the rotary electric machine MG to increase along with the increase in the vehicle speed (output rotational speed) and cause the first engagement device CL1 to rotationally synchronize. Note that an adding value of the rotational speed may not be a constant value, but may increase or decrease.

In a case in which the rotational speed difference Δω1 between the engagement members of the first engagement device CL1 becomes equal to or less than a specified value that is previously determined, the temperature increase suppression control section 47 determines that the direct engagement transition condition for the first engagement device CL1 is satisfied (time T26). The temperature increase suppression control section 47 causes the first target torque capacity of the first engagement device CL1 to increase up to the full engagement capacity and causes the first engagement device CL1 to transition to the direct engaged state.

In a case in which the vehicle speed further increases and the rotational speed difference between the engagement members of the second engagement device CL2 becomes equal to or less than a specified value that is previously determined, the temperature increase suppression control section 47 determines that the direct engagement transition condition for the second engagement device CL2 is satisfied (time T27). The temperature increase suppression control section 47 causes the second target torque capacity of the second engagement device CL2 to increase up to the full engagement capacity and causes the second engagement device CL2 to transition to the direct engaged state, and terminates the second engagement slip control and the temperature increase suppression control.

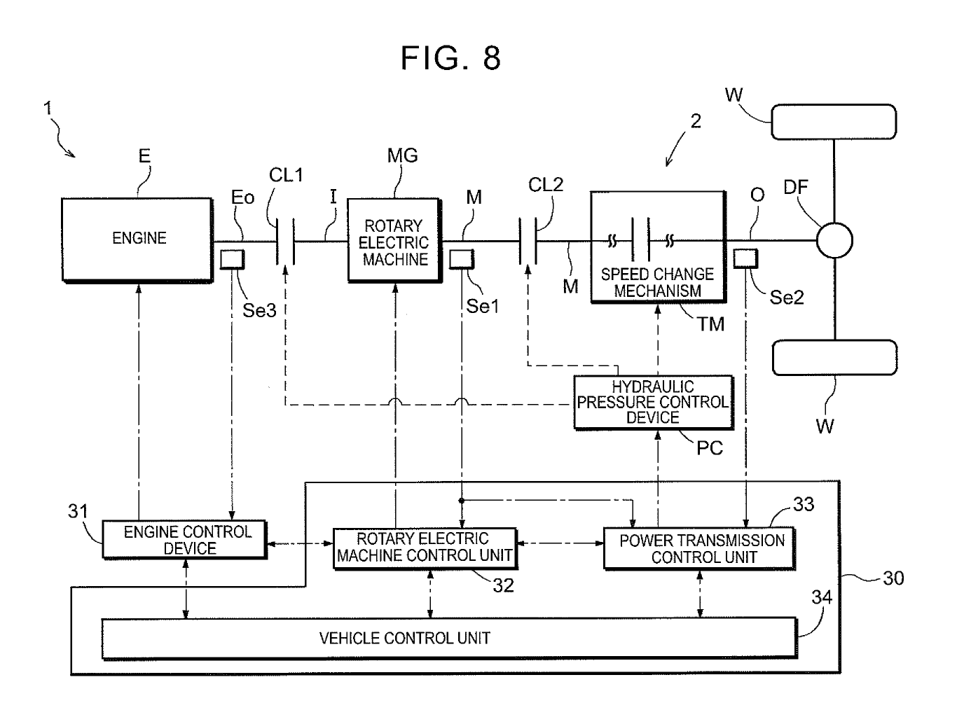

(2) In the aforementioned embodiment, a case was explained as an example, in which one of a plurality of engagement devices of the speed change mechanism TM is set as the second engagement device CL2 that is controlled so as to be in the slip engaged state during the first engagement slip control. However, embodiments are not limited thereto. As shown in FIG. 8, the vehicular drive device 1 may be further provided with an engagement device on the power transmission path 2 between the rotary electric machine MG and the speed change mechanism TM, and the engagement device may be configured to be set as the second engagement device CL2 that is controlled so as to be in the slip engaged state during the first engagement slip control. Alternatively, the vehicular drive device 1 shown in FIG. 8 may be configured not to be provided with the speed change mechanism TM.

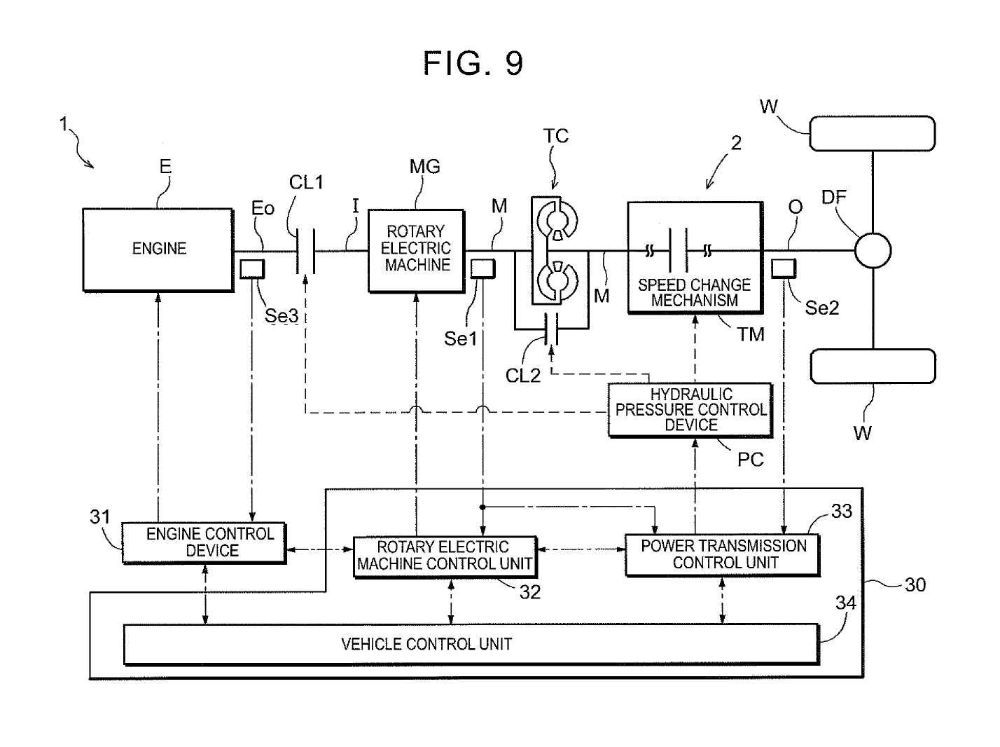

Alternatively, as shown in FIG. 9, the vehicular drive device 1 may be further provided with a torque converter TC on the power transmission path between the rotary electric machine MG and the speed change mechanism TM, and a lockup clutch that makes the direct engaged state between input-output members of the torque converter TC may be configured to be set as the second engagement device CL2 that is controlled so as to be in the slip engaged state during the first engagement slip control.

(3) In the aforementioned embodiment, a case was explained as an example, in which the first engagement device CL1 and the second engagement device CL2 are engagement devices that are controlled with hydraulic pressure. However, embodiments are not limited thereto. One or both of the first engagement device CL1 and the second engagement device CL2 may be engagement devices that are controlled with driving force other than hydraulic pressure, for example, electromagnetic driving force, driving force by servomotor, etc.

(4) In the aforementioned embodiment, a case was explained as an example, in which the speed change mechanism TM is an automatic stepped speed change mechanism. However, embodiments are not limited thereto. The speed change mechanism TM may be configured to be a speed change mechanism other than the automatic speed change mechanism, such as an automatic continuously variable transmission that is capable of continuously changing the speed ratio. Also, in such a case, an engagement device provided in the speed change mechanism TM may be set as the second engagement device CL2 whose engagement state is controlled so as to be in the slip engaged state during the first engagement slip control. Alternatively, an engagement device installed separately from the speed change mechanism TM may be set as the second engagement device CL2.

(5) In the aforementioned embodiment, a case was explained as an example, in which the control device 30 includes a plurality of control units 32 to 34 and these plurality of control units 32 to 34 include a plurality of function sections 41 to 47. However, embodiments are not limited thereto. The control device 30 may include the aforementioned plurality of control units 32 to 34 as control devices which are integrated or separated in any combination. The allocation of the plurality of function sections 41 to 47 may be made as desired. For example, in a case in which the second engagement device CL2 is one of the engagement device of the speed change mechanism TM, the speed change mechanism control section 43 and the second engagement device control section 45 may be integrated.

(6) In the aforementioned embodiment, a case was explained as an example, in which the temperature increase suppression control section 47 is configured to execute the rotation stop motor assistance control in a case in which the temperature of the first engagement device CL1 has exceeded the auxiliary threshold value. However, embodiments are not limited thereto. The temperature increase suppression control section 47 may be configured not to execute the rotation stop motor assistance control in a case in which the temperature of the first engagement device CL1 has exceeded the auxiliary threshold value. Specifically, the temperature increase suppression control section 47 may be configured to execute the transmission torque control without performing the rotation stop motor assistance control in a case in which the temperature of the first engagement device CL1 is equal to or greater than the auxiliary threshold value and less than the slip threshold value.

In such a case, the temperature increase suppression control section 47 is configured to, in a case in which the temperature of the first engagement device CL1 increases in a state in which the rotation of the wheels W has stopped, merely execute, as the temperature increase suppression control, the slip transition control that causes the second engagement device CL2 to transition to the slip engaged state, causes the rotational speed of the rotary electric machine MG to increase and the output torque of the rotary electric machine MG to increase, and causes the transmission torque of the first engagement device CL1 to decrease.

(7) In the aforementioned embodiment, a case was explained as an example, in which the temperature increase suppression control section 47 is configured to cause the second engagement device CL2 to transition to the slip engaged state and execute the transmission torque limitation motor assistance control in a case in which it is determined that the temperature of the first engagement device CL1 has exceeded the slip threshold value. However, embodiments are not limited thereto. The temperature increase suppression control section 47 may be configured not to cause the second engagement device CL2 to transition to the slip engaged state and not to execute the transmission torque limitation motor assistance control in a case in which it is determined that the temperature of the first engagement device CL1 has exceeded the slip threshold value. Specifically, the temperature increase suppression control section 47 may be configured to execute the rotation stop motor assistance control even in a case in which the temperature of the first engagement device CL1 becomes equal to or greater than the slip threshold value.

In such a case, the temperature increase suppression control section 47 is configured to, in a case in which the temperature of the first engagement device CL1 increases in a state in which the rotation of the wheels W has stopped during the first engagement slip control, merely execute the direct engagement maintaining control that causes the output torque of the rotary electric machine MG to increase and causes the transmission torque of the first engagement device CL1 to decrease while continuing to control the second engagement device CL2 so as to be in the direct engaged state, as the temperature increase suppression control.

(8) In the aforementioned embodiment, a case was explained as an example, in which the temperature increase suppression control section 47 is configured to, after starting the execution of the transmission torque control motor assistance control, in accordance with the decrease in the rotational speed difference Δω1 between the engagement members of the first engagement device CL1, cause the first target torque capacity of the first engagement device CL1 to increase and causes the rotary electric machine required torque of the rotary electric machine MG to decrease. However, embodiments are not limited thereto. After starting the execution of the transmission torque limitation motor assistance control, the temperature increase suppression control section 47 may be configured not to change the first target torque capacity of the first engagement device CL1 but to maintain the value set after starting the execution regardless of the decrease in the rotational speed difference Δω1 between the engagement members of the first engagement device CL1.

(9) In the aforementioned embodiment, a case was explained as an example, in which the temperature increase suppression control section 47 is configured to cause the transmission torque of the first engagement device CL1 to decrease in accordance with the amount of increase in the output torque of the rotary electric machine MG. However, embodiments are not limited thereto. It is not necessary that the amount of increase in the output torque of the rotary electric machine MG corresponds to the amount of decrease in the transmission torque of the first engagement device CL1, provided that the temperature increase suppression control section 47 is configured to cause the output torque of the rotary electric machine MG to increase and cause the transmission torque of the first engagement device CL1 to decrease. For example, in a case in which the amount of increase in the output torque of the rotary electric machine MG is limited, the amount of decrease in the transmission torque of the first engagement device CL1 may be greater compared to the amount of increase in the output torque of the rotary electric machine MG.

(10) In the aforementioned embodiment, a case was explained as an example, in which the temperature increase suppression control section 47 is configured to, as the rotation stop motor assistance control, cause the output torque of the rotary electric machine MG to increase to the extent that the increase in the temperature of the rotary electric machine MG is within the allowable range that is previously determined in a state in which the rotation of the rotary electric machine MG has stopped, and cause the transmission torque of the first engagement device CL1 to decrease in accordance with the amount of increase in the output torque of the rotary electric machine MG. However, embodiments are not limited thereto. The temperature increase suppression control section 47 is only necessary to be configured to cause the output torque of the rotary electric machine MG to increase and cause the transmission torque of the first engagement device CL1 to decrease, or cause the transmission torque of the first engagement device CL1 to decrease in accordance with the amount of increase in the output torque of the rotary electric machine MG while continuing to control the second engagement device CL2 so as to be in the direct engaged state.

(11) In the aforementioned embodiment, a case was explained as an example, in which the temperature increase suppression control section 47 is configured to, as the transmission torque limitation motor assistance control, cause the transmission torque of the first engagement device CL1 to decrease such that the increase in the temperature of the first engagement device CL1 becomes within the allowable range and cause the output torque of the rotary electric machine MG to increase in accordance with the amount of decrease in the transmission torque of the first engagement device CL1. However, embodiments are not limited thereto. The temperature increase suppression control section 47 is only necessary to be configured to, as the transmission torque limitation motor assistance control, cause the output torque of the rotary electric machine MG to increase and the transmission torque of the first engagement device CL1 to decrease, or cause the transmission torque of the first engagement device CL1 to decrease in accordance with the amount of increase in the output torque of the rotary electric machine MG.

### INDUSTRIAL APPLICABILITY

Preferred embodiments may be preferably applied to a control device that controls a vehicular drive device in which a first engagement device, a rotary electric machine, and a second engagement device are arranged in this order from an internal combustion engine on a power transmission path that connects an internal combustion engine to wheels.

### DESCRIPTION OF THE REFERENCE NUMERALS

Δω1/ROTATIONAL SPEED DIFFERENCE BETWEEN ENGAGEMENT MEMBERS OF FIRST ENGAGEMENT DEVICE
1/VEHICULAR DRIVE DEVICE
2/POWER TRANSMISSION PATH
30/CONTROL DEVICE OF VEHICULAR DRIVE DEVICE
31/ENGINE CONTROL DEVICE
32/ROTARY ELECTRIC MACHINE CONTROL UNIT
33/POWER TRANSMISSION CONTROL UNIT
34/VEHICLE CONTROL UNIT
41/ENGINE CONTROL SECTION
42/ROTARY ELECTRIC MACHINE CONTROL SECTION
43/SPEED CHANGE MECHANISM CONTROL SECTION
44/FIRST ENGAGEMENT DEVICE CONTROL SECTION
45/SECOND ENGAGEMENT DEVICE CONTROL SECTION
46/FIRST ENGAGEMENT SLIP CONTROL SECTION
47/TEMPERATURE INCREASE SUPPRESSION CONTROL SECTION
CL1/FIRST ENGAGEMENT DEVICE
CL2/SECOND ENGAGEMENT DEVICE
E/ENGINE (INTERNAL COMBUSTION ENGINE)
EO/ENGINE OUTPUT SHAFT
I/INPUT SHAFT
M/INTERMEDIATE SHAFT
MG/ROTARY ELECTRIC MACHINE
O/OUTPUT SHAFT
PC/HYDRAULIC PRESSURE CONTROL DEVICE
SE1/INPUT ROTATIONAL SPEED SENSOR
SE2/OUTPUT ROTATIONAL SPEED SENSOR
SE3/ENGINE ROTATIONAL SPEED SENSOR
TM/SPEED CHANGE MECHANISM
W/WHEEL

1-12. (canceled)

13. A control device configured to control a vehicular drive device in which a first engagement device, a rotary electric machine, and a second engagement device are arranged in this order from an internal combustion engine side on a power transmission path that connects the internal combustion engine to wheels, the control device comprising:
a first engagement slip control section configured to perform first engagement slip control that, during rotation operation of the internal combustion engine, controls the second engagement device so as to be in a direct engaged state and the first engagement device so as to be in a slip engaged state; and
a temperature increase suppression control section that, in a case in which temperature of the first engagement device increases during the first engagement slip control, causes output torque of the rotary electric machine to increase and causes transmission torque of the first engagement device to decrease.

14. The control device of the vehicular drive device according to claim 13, wherein the temperature increase suppression control section causes the transmission torque of the first engagement device to decrease to a value that is greater than zero.

15. The control device of the vehicular drive device according to claim 13, wherein, in a case in which the temperature of the first engagement device increases in a state in which rotation of the wheels has stopped during the first engagement slip control, the temperature increase suppression control section executes slip transition control that causes the second engagement device to transition from the direct engaged state to the slip engaged state and causes rotational speed of the rotary electric machine to increase, and causes the output torque of the rotary electric machine to increase and the transmission torque of the first engagement device to decrease.

16. The control device of the vehicular drive device according to claim 14, wherein, in a case in which the temperature of the first engagement device increases in a state in which rotation of the wheels has stopped during the first engagement slip control, the temperature increase suppression control section executes slip transition control that causes the second engagement device to transition from the direct engaged state to the slip engaged state and causes rotational speed of the rotary electric machine to increase, and causes the output torque of the rotary electric machine to increase and the transmission torque of the first engagement device to decrease.

17. The control device of the vehicular drive device according to claim 13, wherein, in a case in which the temperature of the first engagement device increases in a state in which rotation of the wheels has stopped during the first engagement slip control, the temperature increase suppression control section executes direct engagement maintaining control that causes the output torque of the rotary electric machine to increase and causes the transmission torque of the first engagement device to decrease while continuing to control the second engagement device so as to be in the direct engaged state.

18. The control device of the vehicular drive device according to claim 14, wherein, in a case in which the temperature of the first engagement device increases in a state in which rotation of the wheels has stopped during the first engagement slip control, the temperature increase suppression control section executes direct engagement maintaining control that causes the output torque of the rotary electric machine to increase and causes the transmission torque of the first engagement device to decrease while continuing to control the second engagement device so as to be in the direct engaged state.

19. The control device of the vehicular drive device according to claim 13, wherein, in a state in which rotation of the wheels has stopped during the first engagement slip control,
in a case in which the temperature of the first engagement device exceeds a predetermined first threshold value, the temperature increase suppression control section executes direct engagement maintaining control that causes the output torque of the rotary electric machine to increase and causes the transmission torque of the first engagement device to decrease while continuing to control the second engagement device so as to be in the direct engaged state, and
in a case in which the temperature of the first engagement device exceeds a predetermined second threshold value that is greater than the first threshold value, the temperature increase suppression control section executes slip transition control that causes the second engagement device to transition from the direct engaged state to the slip engaged state and causes rotational speed of the rotary electric machine to increase, and causes the output torque of the rotary electric machine to increase and the transmission torque of the first engagement device to decrease.

20. The control device of the vehicular drive device according to claim 14, wherein, in a state in which rotation of the wheels has stopped during the first engagement slip control,
in a case in which the temperature of the first engagement device exceeds a predetermined first threshold value, the temperature increase suppression control section executes direct engagement maintaining control that causes the output torque of the rotary electric machine to increase and causes the transmission torque of the first engagement device to decrease while continuing to control the second engagement device so as to be in the direct engaged state, and
in a case in which the temperature of the first engagement device exceeds a predetermined second threshold value that is greater than the first threshold value, the temperature increase suppression control section executes slip transition control that causes the second engagement device to transition from the direct engaged state to the slip engaged state and causes rotational speed of the rotary electric machine to increase, and causes the output torque of the rotary electric machine to increase and the transmission torque of the first engagement device to decrease.

21. The control device of the vehicular drive device according to claim 13, wherein, in a case in which the temperature of the first engagement device increases in a state in which the wheels are rotating during the first engagement slip control, the temperature increase suppression control section executes during-rotation control that causes the output torque of the rotary electric machine to increase and the transmission torque of the first engagement device to decrease while continuing to control the second engagement device so as to be in the direct engaged state.

22. The control device of the vehicular drive device according to claim 14, wherein, in a case in which the temperature of the first engagement device increases in a state in which the wheels are rotating during the first engagement slip control, the temperature increase suppression control section executes during-rotation control that causes the output torque of the rotary electric machine to increase and the transmission torque of the first engagement device to decrease while continuing to control the second engagement device so as to be in the direct engaged state.

23. The control device of the vehicular drive device according to claim 13, wherein, in causing the output torque of the rotary electric machine to increase and the transmission torque of the first engagement device to decrease, the temperature increase suppression control section causes the transmission torque of the first engagement device to decrease in accordance with an amount of increase in the output torque of the rotary electric machine.

24. The control device of the vehicular drive device according to claim 14, wherein, in causing the output torque of the rotary electric machine to increase and the transmission torque of the first engagement device to decrease, the temperature increase suppression control section causes the transmission torque of the first engagement device to decrease in accordance with an amount of increase in the output torque of the rotary electric machine.

25. The control device of the vehicular drive device according to claim 15, wherein, in causing the output torque of the rotary electric machine to increase and the transmission torque of the first engagement device to decrease in the slip transition control, the temperature increase suppression control section causes the transmission torque of the first engagement device to decrease such that an increase in the temperature of the first engagement device becomes within a predetermined allowable range and causes the output torque of the rotary electric machine to increase in accordance with an amount of decrease in the transmission torque of the first engagement device.

26. The control device of the vehicular drive device according to claim 16, wherein, in causing the output torque of the rotary electric machine to increase and the transmission torque of the first engagement device to decrease in the slip transition control, the temperature increase suppression control section causes the transmission torque of the first engagement device to decrease such that an increase in the temperature of the first engagement device becomes within a predetermined allowable range and causes the output torque of the rotary electric machine to increase in accordance with an amount of decrease in the transmission torque of the first engagement device.

27. The control device of the vehicular drive device according to claim 17, wherein, in causing the output torque of the rotary electric machine to increase and the transmission torque of the first engagement device to decrease in the direct engagement maintaining control, the temperature increase suppression control section causes the output torque of the rotary electric machine to increase to an extent that an increase in the temperature of the rotary electric machine becomes within a predetermined allowable range in a state in which rotation of the rotary electric machine has stopped and causes the transmission torque of the first engagement device to decrease in accordance with an amount of increase in the output torque of the rotary electric machine.

28. The control device of the vehicular drive device according to claim 18, wherein, in causing the output torque of the rotary electric machine to increase and the transmission torque of the first engagement device to decrease in the direct engagement maintaining control, the temperature increase suppression control section causes the output torque of the rotary electric machine to increase to an extent that an increase in the temperature of the rotary electric machine becomes within a predetermined allowable range in a state in which rotation of the rotary electric machine has stopped and causes the transmission torque of the first engagement device to decrease in accordance with an amount of increase in the output torque of the rotary electric machine.

29. The control device of the vehicular drive device according to claim 21, wherein, in causing the output torque of the rotary electric machine to increase and the transmission torque of the first engagement device to decrease in the during-rotation control, the temperature increase suppression control section causes the transmission torque of the first engagement device to decrease such that an increase in the temperature of the first engagement device becomes within a predetermined allowable range and causes the output torque of the rotary electric machine to increase in accordance with an amount of decrease in the transmission torque of the first engagement device.

30. The control device of the vehicular drive device according to claim 22, wherein, in causing the output torque of the rotary electric machine to increase and the transmission torque of the first engagement device to decrease in the during-rotation control, the temperature increase suppression control section causes the transmission torque of the first engagement device to decrease such that an increase in the temperature of the first engagement device becomes within a predetermined allowable range and causes the output torque of the rotary electric machine to increase in accordance with an amount of decrease in the transmission torque of the first engagement device.

31. The control device of the vehicular drive device according to claim 15, wherein, after the second engagement device is caused to transition to the slip engaged state in the slip transition control and the wheels start to rotate, the temperature increase suppression control section causes the second engagement device to transition from the slip engaged state to the direct engaged state.

32. The control device of the vehicular drive device according to claim 16, wherein, after the second engagement device is caused to transition to the slip engaged state in the slip transition control and the wheels start to rotate, the temperature increase suppression control section causes the second engagement device to transition from the slip engaged state to the direct engaged state.

33. The control device of the vehicular drive device according to claim 15, wherein, after the second engagement device is caused to transition to the slip engaged state in the slip transition control and the wheels start to rotate, the temperature increase suppression control section causes the first engagement device to transition from the slip engaged state to the direct engaged state, and thereafter, causes the second engagement device to transition from the slip engaged state to the direct engaged state.

34. The control device of the vehicular drive device according to claim 16, wherein, after the second engagement device is caused to transition to the slip engaged state in the slip transition control and the wheels start to rotate, the temperature increase suppression control section causes the first engagement device to transition from the slip engaged state to the direct engaged state, and thereafter, causes the second engagement device to transition from the slip engaged state to the direct engaged state.
